(19) United States
(12) Patent Application Publication
(10) Pub. No.: US 2025/0126635 A1
(43) Pub. Date: Apr. 17, 2025

(54) MANAGING COEXISTENCE OF USER EQUIPMENT-BASED AND RANDOM ACCESS CHANNEL-BASED TIMING ADVANCE VALUES

(71) Applicant: Nokia Technologies Oy, Espoo (FI)

(72) Inventors: Umur KARABULUT, Munich (DE); Anastasios KAKKAVAS, Munich (DE); Sanjay GOYAL, Murray Hill, NJ (US); Ali KARIMIDEHKORDI, Munich (DE); Panagiotis SPAPIS, Munich (DE)

(21) Appl. No.: 18/911,617

(22) Filed: Oct. 10, 2024

Related U.S. Application Data
(60) Provisional application No. 63/589,787, filed on Oct. 12, 2023.

(51) Int. Cl. H04W 74/00; H04W 48/20; H04W 72/02; H04W 72/044; H04W 72/23

(52) U.S. Cl. CPC H04W 74/004; H04W 48/20; H04W 72/02; H04W 72/044; H04W 72/23

(57) ABSTRACT

A method is provided that includes receiving a configuration of selection criteria for a timing advance (TA) of a target cell, acquired by respective acquisition schemes including a user equipment (UE)-based acquisition scheme and a random access channel (RACH)-based acquisition scheme. The method includes acquiring a UE-based TA value according to the UE-based acquisition scheme, and transmitting a random access preamble to the target cell that is configured to acquire a RACH-based TA value according to the RACH-based acquisition scheme. The method includes receiving a cell-switch command from a serving cell to trigger a cell switch to the target cell, after the UE-based TA value and the RACH-based TA value are acquired. And the method includes accessing the target cell using a TA value selected from the UE-based TA value and the RACH-based TA value, based on the configuration.

### TECHNOLOGICAL FIELD

The present disclosure relates generally to telecommunications and, in particular, to managing coexistence of user equipment-based and random access channel-based timing advance values.

### BACKGROUND

A telecommunications system can be seen as a facility that enables communication sessions between two or more entities such as user terminals, base stations and/or other nodes by providing carriers between the various entities involved in the communications path. A telecommunications system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless telecommunications system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the telecommunications system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The telecommunications system and associated devices typically operate in accordance with a given standard or specification which sets out what the various entities associated with the system are permitted to do and how that should be achieved. Communication protocols and/or parameters which shall be used for the connection are also typically defined. One example of a telecommunications system is the Universal Mobile Telecommunications System (UMTS). Other examples of telecommunications systems are Long-Term Evolution (LTE), LTE Advanced and the so-called 5G or New Radio (NR) networks. NR is being standardized by the 3rd Generation Partnership Project (3GPP).

A more recent enhancement in 3GPP is lower-layer triggered mobility (LTM), which involves moving execution of handover based mobility from one cell to another from higher layers to lower layers. Relative to higher layer mobility, LTM is being designed to reduce latency, overhead and interruption time. In this regard, LTM supports an early synchronization to one or more candidate target cells, during which a UE may acquire a timing advance (TA) of respective ones of the candidate target cell(s). This early synchronization may reduce interruption during LTM execution.

In an LTM procedure, the TA of the candidate target cell(s) may be acquired according to a random access channel (RACH)-based acquisition scheme. Other schemes for acquiring the TA may be RACH-less schemes. One example is a UE-based acquisition scheme in which the UE may derive the TA based on a receive timing difference between its current serving cell and a candidate target cell, as well as a TA value for the serving cell.

A UE may be able to support both the UE-based acquisition scheme and the RACH-based acquisition scheme. In that case, UE can be configured for both the UE-based acquisition scheme and RACH-based acquisition scheme. This may help reduce issues that can be caused by the TA acquisition. However, when the TA values of both schemes are acquired and available, it is not trivial to tell which TA value should be used by the UE. It is also not clear how to handle transmission configuration indicator (TCI) states (beams) given to the UE with a cell switch command when there are two TA values subject to use. In this regard, a mismatch may be created when the UL grant and TCI states are provided for use with one of the TA values, and the UE uses the other TA value.

### BRIEF SUMMARY

Example implementations of the present disclosure are directed generally to telecommunications and, in particular, to managing coexistence of user equipment-based and random access channel-based timing advance values. The present disclosure includes, without limitation, the following example implementations.

Some example implementations provide an apparatus comprising: at least one memory configured to store computer-readable program code; and at least one processing circuitry configured to access the at least one memory, and execute the computer-readable program code to cause the apparatus to at least: receive a configuration of selection criteria for a timing advance (TA) of a target cell, acquired by respective acquisition schemes including a user equipment (UE)-based acquisition scheme and a random access channel (RACH)-based acquisition scheme; acquire a UE-based TA value according to the UE-based acquisition scheme; transmit a random access preamble to the target cell that is configured to acquire a RACH-based TA value according to the RACH-based acquisition scheme; receive a cell-switch command from a serving cell to trigger a cell switch to the target cell, after the UE-based TA value and the RACH-based TA value are acquired; and access the target cell using a TA value selected from the UE-based TA value and the RACH-based TA value, based on the configuration.

Some example implementations provide a method comprising: receiving a configuration of selection criteria for a timing advance (TA) of a target cell, acquired by respective acquisition schemes including a user equipment (UE)-based acquisition scheme and a random access channel (RACH)-based acquisition scheme; acquiring a UE-based TA value according to the UE-based acquisition scheme; transmitting a random access preamble to the target cell that is configured to acquire a RACH-based TA value according to the RACH-based acquisition scheme; receiving a cell-switch command from a serving cell to trigger a cell switch to the target cell, after the UE-based TA value and the RACH-based TA value are acquired; and accessing the target cell using a TA value selected from the UE-based TA value and the RACH-based TA value, based on the configuration.

Some example implementations provide an apparatus comprising: at least one memory configured to store computer-readable program code; and at least one processing circuitry configured to access the at least one memory, and execute the computer-readable program code to cause the apparatus to at least: receive a configuration of selection criteria for a timing advance (TA) of a target cell, acquired by respective acquisition schemes including a user equipment (UE)-based acquisition scheme and a random access channel (RACH)-based acquisition scheme; transmit a TA-acquisition command to a user equipment to trigger the user equipment to transmit a random access preamble to the target cell that is configured to acquire a RACH-based TA value according to the RACH-based acquisition scheme, the user equipment configured to acquire a UE-based TA value according to the UE-based acquisition scheme; determine cell-selection information based on the configuration; and transmit a cell-switch command to the user equipment to trigger a cell switch to the target cell, after the UE-based TA value and the RACH-based TA value are acquired, the cell-switch command including the cell-selection information, the user equipment configured to access the target cell using a TA value selected from the UE-based TA value and the RACH-based TA value, based on the configuration and the cell-selection information.

Some example implementations provide a method comprising: receiving a configuration of selection criteria for a timing advance (TA) of a target cell, acquired by respective acquisition schemes including a user equipment (UE)-based acquisition scheme and a random access channel (RACH)-based acquisition scheme; transmitting a TA-acquisition command to a user equipment to trigger the user equipment to transmit a random access preamble to the target cell that is configured to acquire a RACH-based TA value according to the RACH-based acquisition scheme, the user equipment configured to acquire a UE-based TA value according to the UE-based acquisition scheme; determining cell-selection information based on the configuration; and transmitting a cell-switch command to the user equipment to trigger a cell switch to the target cell, after the UE-based TA value and the RACH-based TA value are acquired, the cell-switch command including the cell-selection information, the user equipment configured to access the target cell using a TA value selected from the UE-based TA value and the RACH-based TA value, based on the configuration and the cell-selection information.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIG. 1 illustrates a telecommunications system that includes one or more public land mobile networks (PLMNs) coupled to one or more external data networks, according to some example implementations of the present disclosure;

FIG. 2 illustrates a 5G deployment of a PLMN, according to some example implementations;

FIG. 3 illustrates an overview of a portion of the 5G radio protocol stack architecture, according to some example implementations;

FIG. 4 illustrates a signaling chart for a lower-layer triggered mobility (LTM) procedure;

FIGS. 5A and 5B illustrate a signaling chart for an LTM procedure in a CU-DU split architecture;

FIG. 6 illustrates a user equipment (UE)-based timing advance (TA) acquisition scheme, according to some example implementations;

FIGS. 7A and 7B illustrate a signaling chart for an LTM procedure in a CU-DU split architecture, according to some example implementations;

FIGS. 8A, 8B, 8C, 8D, 8E and 8F are flowcharts illustrating various steps in a method that may be implemented by a user equipment, according to various example implementations;

FIGS. 9A, 9B, 9C and 9D are flowcharts illustrating various steps in a method that may be implemented by a serving cell, according to various example implementations; and

FIG. 10 illustrates an apparatus according to some example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably. The term “network” may refer to a group of interconnected computers including clients and servers; and within a network, these computers may be interconnected directly or indirectly by various means including via one or more switches, routers, gateways, access points or the like.

Reference may be made herein to terms specific to a particular system, architecture or the like, but it should be understood that example implementations of the present disclosure may be equally applicable to any of a number of systems, architectures and the like. For example, reference may be made to 3GPP technologies such as Global System for Mobile Communications (GSM), UMTS, LTE, LTE Advanced, 5G NR, 5G Advanced and 6G; however, it should be understood that example implementations of the present disclosure may be equally applicable to non-3GPP technologies such as IEEE 802, Bluetooth and Bluetooth Low Energy.

Further, as used in this application, the term “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions); or (c) hardware circuit(s) and/or processor(s), such as a microprocessor(s) or a portion of a microprocessor(s), that requires software (e.g., firmware) for operation, but the software may not be present when it is not needed for operation.

The above definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

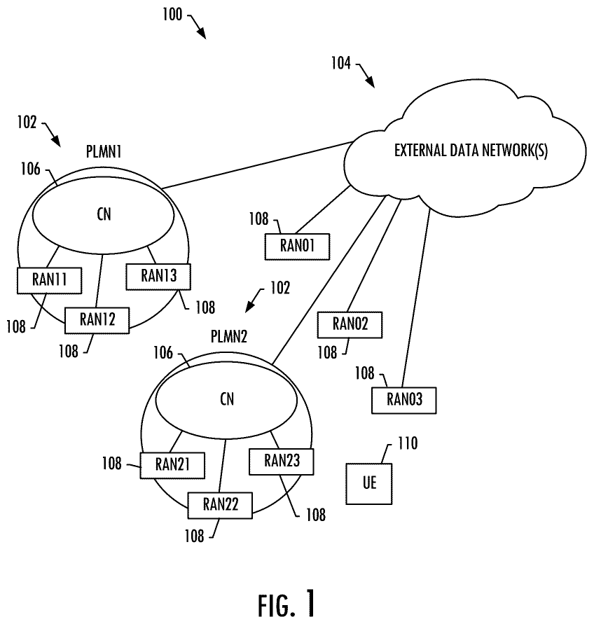

FIG. 1 illustrates a telecommunications system 100 according to various example implementations of the present disclosure. The telecommunications system generally includes one or more telecommunications networks. As shown, for example, the system includes one or more public land mobile networks (PLMNs) 102 coupled to one or more other external data networks 104-notably including a wide area network (WAN) such as the Internet. Each of the PLMNs includes a core network (CN) 106 backbone such as the Evolved Packet Core (EPC) of LTE, the 5G core network (5GC) or the like; and each of the core networks and the Internet are coupled to one or more radio access networks (RANs) 108, air interfaces or the like that implement one or more radio access technologies (RATs). As used herein, a “network device” refers to any suitable device at a network side of a telecommunications network. Examples of suitable network devices are described in greater detail below.

In addition, the system includes one or more radio units that may be varyingly known as user equipment (UE) 110, terminal device, terminal equipment, mobile station or the like. The UE is generally a device configured to communicate with a network device or a further UE in a telecommunication network. The UE may be a portable computer (e.g., laptop, notebook, tablet computer), mobile phone (e.g., cell phone, smartphone), wearable computer (e.g., smartwatch), or the like. In other examples, the UE may be an Internet of things (IoT) device, an industrial IoT (IIOT device), a vehicle equipped with a vehicle-to-everything (V2X) communication technology, or the like. In operation, these UEs may be configured to connect to one or more of the RANs 108 according to their particular radio access technologies to thereby access a particular CN 106 of a PLMN 102, or to access one or more of the external data networks 104 (e.g., the Internet). The external data network may be configured to provide Internet access, operator services, 3rd party services, etc. For example, the International Telecommunication Union (ITU) has classified 5G mobile network services into three categories: enhanced mobile broadband (eMBB), ultra-reliable and low-latency communications (URLLC), and massive machine type communications (mMTC) or massive internet of things (MIOT).

Examples of radio access technologies include 3GPP radio access technologies such as GSM, UMTS, LTE, LTE Advanced, 5G NR, 5G Advanced, and 6G. Other examples of radio access technologies include IEEE 802 technologies such as IEEE 802.11 (Wi-Fi), IEEE 802.15 (including 802.15.1 (WPAN/Bluetooth), 802.15.4 (Zigbee) and 802.15.6 (WBAN)), Bluetooth, Bluetooth Low Energy (BLE), ultra wideband (UWB), and the like. Generally, a radio access technology may refer to any 2G, 3G, 4G, 5G, 6G or higher generation mobile communication technology and their different versions, as well as to any other wireless radio access technology that may be arranged to interwork with such a mobile communication technology to provide access to the CN 106 of a mobile network operator (MNO).

In various example, a RAN 108 may be configured as one or more macrocells, microcells, picocells, femtocells or the like. The RAN may generally include one or more radio access nodes that are configured to interact with UEs 110. In various examples, a radio access node may be referred to as a base station (BS), access point (AP), base transceiver station (BTS), Node B (NB), evolved NB (eNB), macro BS, NB (MNB) or eNB (MeNB), home BS, NB (HNB) or eNB (HeNB), next generation NB (gNB), enhanced gNB (en-gNB), next generation eNB (ng-eNB), or the like. Some type of network controlling/governing entity responsible for control of the radio access nodes. The network controlling/governing entity and radio access node may be separate or integrated into a single apparatus. The network controlling/governing entity may include processing circuitry configured to carry out various management functions, etc. The processing circuitry may be associated with a computer-readable storage medium or database for maintaining information required in the management functions.

A RAN 108 may be centralized or distributed. In various examples, components of a RAN may be interconnected by Ethernet, Gigabit Ethernet, Asynchronous Transfer Mode (ATM), optical fiber, dark fiber, passive wavelength division multiplexing (WDM), WDM passive optical network (WDM-PON), optical transport network (OTN), time sensitive networking (TSN) and/or any other data link layer network, possibly including radio links. The RAN may be connected to a CN 106 through one or more gateways, network functions or the like.

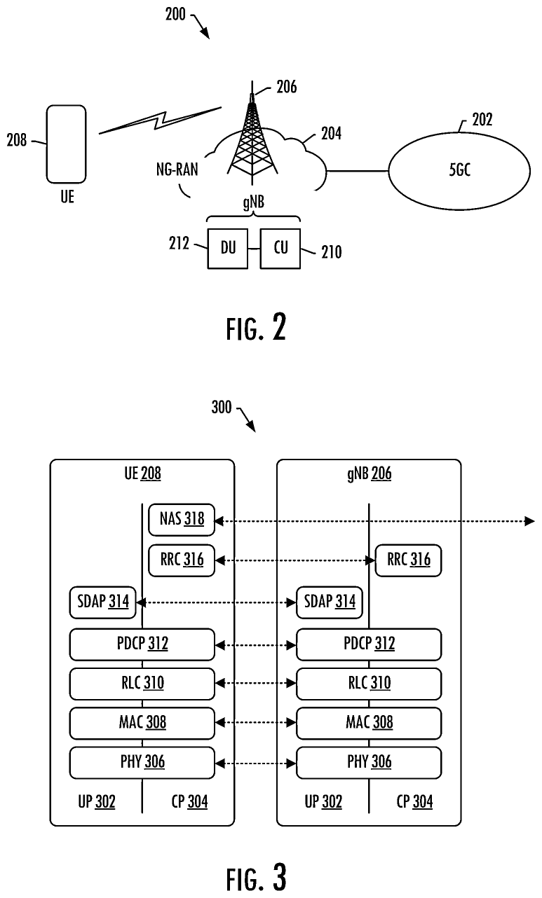

As will be appreciated, a PLMN 102 may be deployed in a number of different manners. In a 4G LTE deployment, the EPC is the CN 106, and the evolved UMTS terrestrial radio access network (E-UTRAN) is the RAN 108; and the E-UTRAN includes one or more eNBs (radio access nodes) configured connect UEs 110 to the E-UTRAN to thereby access the EPC. As shown in FIG. 2, in a 5G deployment 200, the 5GC 202 is the CN, and the next generation (NG) radio access network (NG-RAN) 204 is the RAN; and the NG-RAN includes one or more gNBs 206 (radio access nodes) configured connect UEs 208 to the NG-RAN to thereby access the 5GC. The term ‘gNB’ in 5G may correspond to the eNB in 4G LTE.

Some deployments of 4G LTE and 5G in particular are considered standalone (SA) deployments. Other deployments combine 4G LTE and 5G technologies, and are referred to as non-standalone (NSA) deployments. In some deployments, the E-UTRAN includes one or more ng-eNBs that are configured to communicate with the 5GC, and that may also be configured to communicate with one or more gNBs. Similarly, in another deployment, the NG-RAN may include one or more en-gNBs that are configured to communicate with the EPC, and that may also be configured to communicate with one or more eNBs. In various instances, a single UE 110, 208 a dual-mode or multimode UE, may support multiple (two or more) RANs—thereby being configured to connect to multiple RANs, such as 4G LTE and 5G.

FIG. 3 illustrates an overview of a portion of the 5G radio protocol stack 300 architecture, between the gNB 206 and UE 208, according to some example implementations. As shown, the 5G radio protocol stack has two different stacks depending on the type of data that is processed by the stack. User data goes through a user plane (UP) stack 302, signaling messages go through a control plane (CP) stack 304. Both UP and CP stacks are made up of a common structure including a Layer 1 (L1) with a physical layer (PHY) 306, and a layer 2 (L2) with sublayers including medium access control (MAC) 308, radio link control (RLC) 310, and packet data convergence protocol (PDCP) 312. A layer 3 (L3) sits on top of PHY/MAC/RLC/PDCP, and includes sublayers that are different between the CP and UP. In the UP, L3 includes a sublayer referred to as service data adaptation protocol (SDAP) 314 that is connected to the user plane function (UPF) in the 5GC 202. In the CP, L3 includes two sublayers referred to as radio resource control (RRC) 316 and non-access stratum (NAS) 318, and the NAS layer connects to the access and mobility function (AMF) in the 5GC.

Generally, each layer of the 5G radio protocol stack 300 performs a specific data communications task, a service to and for the layer that precedes it. For example, the RLC 310 provides its services to the PDCP 312. Similarly, the PDCP provides its services to the SDAP 314 (in the UP 302) or the RRC 316 (in the CP 304). The main services or functions of the PDCP include for example: header compression and decompression, transfer of user data, ciphering and deciphering, and timer-based service data unit (SDU) discard.

The process of layers of the 5G radio protocol stack 300 performing specific data communication tasks can be likened to placing a letter in a series of envelopes before it is sent through the postal system. Each succeeding envelope adds another layer of processing or overhead information necessary to process the transaction. Together, all the envelopes help make sure the letter gets to the right address and that the message received is identical to the message sent. Once the entire package is received at its destination, the envelopes are opened one by one until the letter itself emerges exactly as written.

A data flow between a source and destination, such as the UE 208 and 5GC 202, is from top to bottom in the source, across the communications line, and then from bottom to top in the destination. Each time user data passes downward from one layer to the next layer in the source, more processing information is added. When that information is removed and processed by the peer layer in the destination, it causes various tasks (error correction, flow control, etc.) to be performed.

Briefly returning to FIG. 2, radio communications in deployments such as the 5G deployment 200, node operations may in be carried out, at least partly, in a central/centralized unit (CU) 210, such as a server, host or node, operationally coupled to a distributed unit (DU) 212, such as a radio head/node. It is also possible that node operations may be distributed among a plurality of servers, hosts or nodes. It should also be understood that the distribution of work between the 5GC 202 operations and gNB 204 operations may vary depending on implementation. Thus, a 5G network architecture may be based on a so-called CU-DU split. One gNB-CU (central node) may control one or more gNB-DUs. The gNB-CU may control a plurality of spatially separated gNB-DUs, acting at least as transmit/receive (Tx/Rx) nodes. In some example implementations, however, the gNB-DUs (also called DU) may include, for example, the RLC, MAC and PHY, whereas the gNB-CU (also called a CU) may include the layers above RLC, such as PDCP, RRC, and an internet protocol (IP) layer. Other functional splits are also possible. It is considered that skilled person is familiar with the OSI model and the functionalities within each layer.

In some example implementations, the server or CU 210 may generate a virtual network through which the server communicates with the radio node. In general, virtual networking may involve a process of combining hardware and software network resources and network functionality into a single, software-based administrative entity, a virtual network. Such virtual network may provide flexible distribution of operations between the server and the radio head/node. In practice, any digital signal processing task may be performed in either the CU or the DU 212, and the boundary where the responsibility is shifted between the CU and the DU may be selected according to implementation.

Currently in 3GPP, mainstream mobility has been conducted using higher layer (L3 or RRC controlled) mobility. In this regard, L3 handover based mobility is a well-known and proven method for ensuring a robust way of handing over the UE 208 from one serving cell (source cell) of a radio access node (e.g., gNB 206) to a new serving cell (target cell) of the same or another radio access node. The method has been used at least since GSM and is still in use in 5G NR. It is expected that L3 mobility (legacy handover) will also be commonly used in the future.

As the wireless generations evolve, however, so does the need for new and different solutions enabling more flexible, more efficient and sometimes faster procedures making the system seem more agile. One such enhancement includes moving the execution of the ‘handover’ from one cell to another from higher layers (L3), such as RRC 316, to lower layers. These lower layers may be either PHY 306 (or L1) or MAC 308 (or L2). This feature is currently referred to as L1/L2-triggered mobility, or lower-layer triggered mobility (LTM), which may reduce latency, overhead and interruption time when compared to L3 handover based mobility. In a CU-DU split architecture, LTM may support one or more of intra-DU mobility, intra-CU inter-DU mobility, or inter-CU inter-DU mobility.

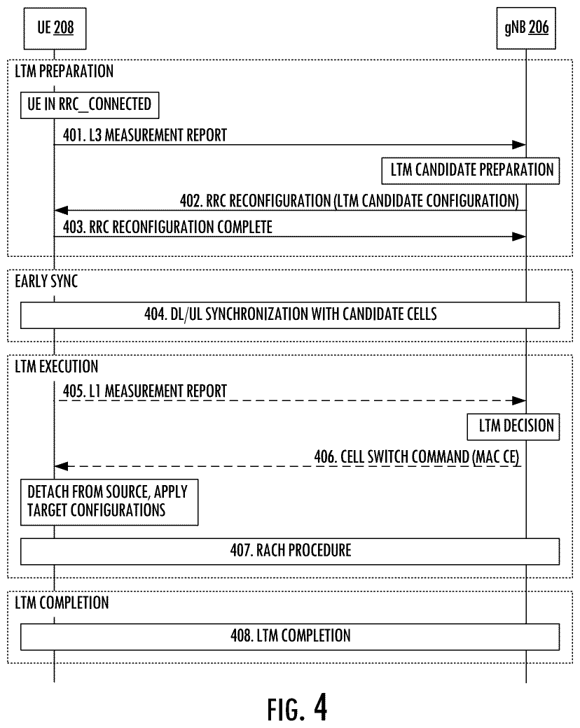

FIG. 4 illustrates a signaling chart for an LTM procedure of a UE 208 in a RRC connected state with a gNB 206, which has been proposed. During LTM preparation, as shown at step 401, the UE sends a L3 measurement report to the gNB, which decides to use LTM and initiate LTM candidate preparation. The gNB at step 402 transmits a RRC reconfiguration message to the UE, including the configuration of one or more candidate target cells. The RRC reconfiguration message may also include a configuration of L1 measurement reporting for LTM execution. The UE stores the configurations, and the UE at step 403 transmits a RRC reconfiguration complete message to the gNB.

An early synchronization of the UE 208 with the candidate target cell(s) follows LTM preparation. As shown at step 404, the UE 208 performs downlink (DL)/uplink (UL) synchronization with the candidate target cell(s). During this procedure, the UE may acquire a timing advance (TA) of respective ones of the candidate target cell(s). This early synchronization may reduce interruption during LTM execution, as compared to L3 handover based mobility. In this regard, the TA may be used to control the timing of uplink transmissions of a UE toward the candidate target cell(s). The UE may likewise have an acquired TA of the cell of the gNB to control the timing of uplink transmissions toward the gNB.

During LTM execution, the UE 208 performs L1 measurements on the configured candidate target cell(s), and the UE at step 405 transmits L1 measurement reports to the gNB 206. The gNB decides to execute a cell switch, and selects one of the candidate target cell(s) as a target cell for the cell switch. The gNB then at step 406 transmits a cell switch command, such as a MAC control element (MAC-CE), to trigger cell switch. The UE switches to the configuration of the target cell; and if the TA of the target cell (from step 404) is no longer available, the UE at step 407 initiates a random access channel (RACH) procedure with the target cell to acquire the TA of the target cell. The UE then at step 408 indicates successful completion of the cell switch.

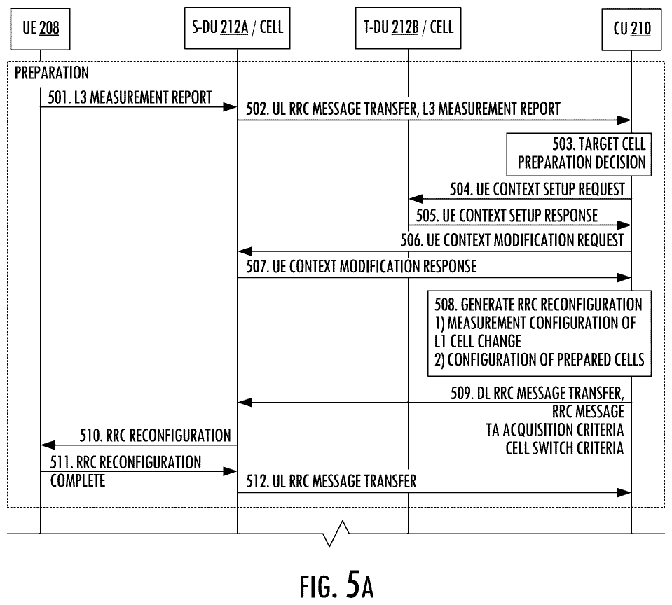

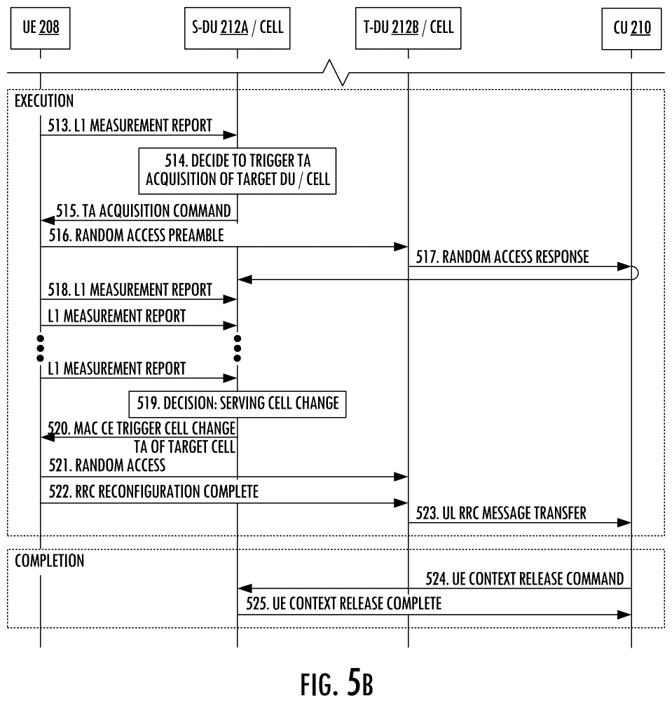

FIGS. 5A and 5B illustrate a signaling chart for an LTM procedure in a CU-DU split architecture, including a CU 210, a source DU (S-DU) 212A for a serving cell, and a target DU (T-DU) 212B for a target cell. During preparation for LTM, as shown at steps 501 and 502, the UE 208 sends a L3 measurement report to the CU via the S-DU, and the CU at step 503 decides prepare one or more candidate target cells (DUs) for LTM. As shown at steps 504, 505, 506 and 507, the CU proceeds with the UE context setup/modification procedures. At step 508, the CU generates RRC reconfiguration(s) for the configured candidate target cell(s); and at steps 509 and 510, the CU provides the configurations to the UE 208 via the S-DU.

At steps 508, 509 and 510, the CU 210 also configures the UE 208 with L1 measurement reporting for LTM execution. The CU provides the S-DU 212A with TA acquisition triggering criteria and configuration(s), as well as cell switch triggering criteria and configuration(s). The triggering criteria for TA acquisition and cell switch may be similar to measurement event report triggering conditions, e.g., A3, A4 or A5 event conditions or validity of acquired TA. The triggering conditions may include, for example, a filter configuration (for L1 measurements), trigger offsets, cell individual offsets, or the like.

At steps 511 and 512, the UE 208 sends a RRC reconfiguration complete to the CU 210 via the S-DU 212A.

During execution, at step 513 onwards, the UE 208 performs L1 measurements on the configured candidate target cell(s), and transmits L1 measurement reports to the S-DU 212A. The S-DU at step 514 decides to trigger the TA acquisition of the candidate target cell(s) (including the cell of T-DU 212B), and the S-DU at step 515 transmits a TA acquisition command to the UE 208. The UE at step 516 transmits a random access preamble to the candidate target cell(s) (T-DU 212B/cell) to signal the candidate target cell(s) to estimate the TA between the UE and the candidate target cell(s). And at step 517, the S-DU 212A/cell receives a random access response (RAR) from respective ones of the candidate target cell(s) indirectly via the CU 210. Alternatively, the UE may receive the RAR of respective ones of the candidate target cell(s), indirectly via the CU and the S-DU.

The UE 208 at step 518 transmits L1 beam measurements of the candidate target cell(s) to the S-DU 212A. The S-DU at steps 519 and 520 decides to initiate a cell change to the T-DU 212B/cell, and transmits a cell switch command (e.g., MAC-CE) to trigger the cell switch. In examples in which the RAR is received at the S-DU at step 517 (instead of the UE), the S-DU provides the TA of the T-DU/cell to the UE. If the TA of the T-DU/cell is still valid, the UE may skip the RACH procedure at step 521 when executing the cell switch. And at steps 522, 523, 524 and 525, the UE, S-DU, T-DU and CU proceed with completion of the LTM procedure.

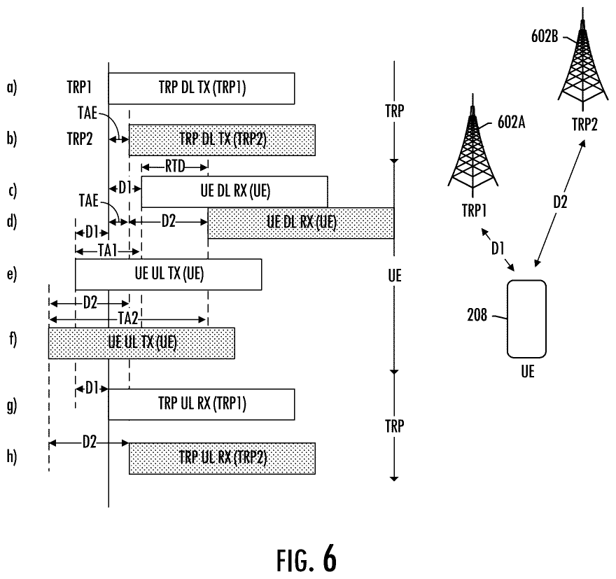

One area of development in LTM relates to early synchronization TA acquisition. In the LTM procedures described above, the TA of the candidate target cell(s) may be acquired according to a RACH-based acquisition scheme. There may be other schemes for acquiring the TA that are RACH-based, and yet other schemes may be RACH-less schemes. One example is a UE-based acquisition scheme in which the UE 208 may derive the TA based on a receive timing difference between its current serving cell and a candidate target cell, as well as a TA value for the serving cell. FIG. 6 illustrates a UE-based acquisition scheme, according to some example implementations.

As shown in FIG. 6, a UE 208 may configured to communicate with multiple transmission-reception points (TRPs) including a first TRP (TRP1) 602A and a second TRP (TRP2) 604B. In this example, the UE may be configured to determine (or estimate) the TA of TRP2 while the UE is served by TRP1. In this regard, the TA of TRP1 (TA1) may be known to the UE, and the UE may determine the TA of TRP2 (TA2) as follows:

$$TA 2 = TA 1 + 2 RTD - 2 Realized ( TAE ) - OtherEstError$$

In the preceding, RTD may represent a round trip delay, TAE may represent a timing alignment error, and OtherEstError may represent any error that can be caused by the UL/DL reciprocity or estimator implementation/method error.

The timing alignment error (TAE) may be the relative difference in time of transmission of the simultaneous signals between TRP1 602A and TRP2 602B. A similar quantity, referred to as cell phase synchronization accuracy, pertains to transmissions from a pair of cells. The cell phase synchronization accuracy for time-division duplex (TDD) may be defined as the maximum absolute deviation in frame start timing between any pair of cells on the same frequency that have overlapping coverage areas.

Furthermore, in the context of DL positioning, a transmit timing error may be defined as the result of a transmit time delay D involved in the transmission of a signal, which may be in turn defined as the time delay from the time when a digital signal is generated at baseband to the time when a corresponding RF signal is transmitted from a transmit antenna. In addition, the round trip delay (RTD) may be provided by an information element NR-RTD-Info, which is used by a location server to provide time synchronization information between a reference TRP and a list of neighbor TRPs. A number of these definitions, information elements and relevant mechanisms are provided in 3GPP specifications, and allow the UE 208 to become aware of timing misalignments in transmissions from different TRPs, and take them into account in position estimation.

As described above, a UE may support multiple schemes for early TA acquisition, such as a RACH-based acquisition scheme and a UE-based acquisition scheme. In RACH-based acquisition, the target cell may determine the TA based on an UL channel transmission from the UE 208 in a RACH procedure. UE-based acquisition may enable the UE 208 to estimate the TA of a target cell without requiring any RACH procedure. The UE may instead determine the TA from existing DL measurements. This may avoid any interruption due to RACH procedure in which a physical RACH (PRACH) preamble transmission towards the target cell may be subject to interruption between the UE and the serving cell.

In the case of either RACH-based acquisition or UE-based acquisition, the TA estimation may be subject to validity after it is estimated or otherwise determined. In this regard, the estimated TA value may change along with the distance that changes between the UE 208 and the target cell, as the TA is correlated with the time that the signal traverses over the air between the UE and the target cell which is subject to change when the UE moves. In the case that the estimated TA changes more than desired (e.g., longer than the cyclic-prefix length), the target cell may be unable to properly decode a UL signal of the UE, which may lead to failure of the RACH-less procedure, or failure of the cell switch.

A UE 208 may be able to support both the UE-based acquisition scheme and the RACH-based acquisition scheme. In that case, UE can be configured by the NG-RAN 204 for both the UE-based acquisition scheme and RACH-based acquisition scheme. This may help reduce issues that can be caused by the TA acquisition. However, when the TA values of both schemes are acquired and available, it is not trivial to tell which TA value should be used by the UE. It is also not clear how to handle transmission configuration indicator (TCI) states (beams) given to the UE with the cell switch command (e.g., MAC-CE) when there are two TA values subject to use. In this regard, a mismatch may be created when the UL grant and TCI states are provided for use with one of the TA values, and the UE uses the other TA value.

Example implementations of the present disclosure therefore provide a solution for managing the coexistence of TA values from different acquisition schemes (e.g., UE-based and RACH-based TA values), which resolves the ambiguity about the TA value to be used by a UE 208 to access a target cell after receiving a cell switch command from its serving cell. According to some example implementations, the solution includes a configuration of the UE by the network (e.g., CU 210) with TA selection criteria to be used by the UE after receiving a cell switch command. In some examples, the TA selection criteria may be based on one or more timers that mark acquisition of the TA values by the respective schemes. The UE or serving cell may then select a first TA value or a second TA value (collectively at times referred to as the TA values) for accessing a target cell based on the configuration, and possibly also the timer(s). And in some examples, the selection of the TA value may be based on one or more beams of the target cell on which the TA values were acquired, which may address the UL grant mismatch issue.

As referenced above and described below, the UE 208 may be capable of TA acquisition according to different schemes. Although primarily described in the context of a UE-based acquisition scheme and a RACH-based acquisition scheme, example implementations may be equally applicable to other TA acquisition schemes. More generally, then, the UE may be capable of implementing both a first acquisition scheme and a second acquisition scheme. A first TA value may be acquired by the first acquisition scheme, and a second TA value may be acquired by the second acquisition scheme.

As described in greater detail below, according to some example implementations, a UE 208 may be configured to receive a configuration of selection criteria for a TA of a target cell (T-DU 212B), acquired by respective acquisition schemes including a UE-based acquisition scheme and a RACH-based acquisition scheme. The UE may be configured to acquire a UE-based TA value according to the UE-based acquisition scheme, and transmit a random access preamble to the target cell that is configured to acquire a RACH-based TA value according to the RACH-based acquisition scheme. The UE may be configured to receive a cell-switch command from a serving cell (S-DU 212A) to trigger a cell switch to the target cell, after the UE-based TA value and the RACH-based TA value are acquired. And the UE may be configured to access the target cell using a TA value selected from the UE-based TA value and the RACH-based TA value, based on the configuration.

In some examples, the serving cell (S-DU 212A) may determine cell-selection information, which the serving cell may include in the cell-switch command to the UE 208. In some examples, the cell-switch command includes the RACH-based TA value, reported to the serving cell by the target cell. In some of these examples, the UE may be configured to select the TA value from the UE-based TA value and the RACH-based TA value, based on the configuration.

In some further examples, the UE 208 may be configured to select a more-recently acquired one of the UE-based TA value or the RACH-based TA value. In other examples, the UE configured to select the TA value may include the UE configured to apply one of the UE-based TA value or the RACH-based TA value for a uplink transmission towards the target cell. And based on a failure of the uplink transmission, the UE apply another of the UE-based TA value or the RACH-based TA value for a retransmission or reattempt of the transmission.

In some examples, the UE may be configured to start one or more timers that mark acquisition of either or both of the UE-based TA value or the RACH-based TA value, based on the configuration; and the TA value may be selected based on the one or more timers.

In some examples, the UE-based TA value and the RACH-based TA value are acquired on one or more beams of the target cell (T-DU 212B), and the TA value may be selected based on the one or more beams. In this regard, the UE-based TA value and the RACH-based TA value may be acquired on a common beam of the target cell, or on different beams of the target cell. And in some further examples, one or more uplink grants may be provided for accessing the target cell, and the TA value is selected based on the one or more uplink grants, and the one or more beams.

In some examples, the configuration of the UE by the network may specify, for example, that the UE select the UE-based TA value when the UE-based TA value and the RACH-based TA value are acquired on a common beam of the target cell. In another example, when the TA values are acquired on different beams, the configuration may specify that the serving cell (S-DU 212A) may acquire multiple UL grants and TCI states, one per beam of multiple beams of the target cell (T-DU 212B), which may include beams that are neighbors of the beam of the RACH-based acquisition. The UE may then use those additional UL grants to select the beam on which the UE acquired the UE-based TA value. And in yet another example, there may be multiple dynamic UL grants for the UE to consider when selecting between the UE-based TA value and the RACH-based TA value.

In some examples, the TA value may be selected at the serving cell (S-DU 212A). In some of these (and other) examples, the UE 208 may be configured to report the UE-based TA value to the serving cell. The UE may be configured to receive a TA-acquisition command from the serving cell to trigger transmission of the random access preamble to the target cell. The serving cell may be configured to select the TA value, based on the configuration. And the serving cell may include cell-selection information in the cell-switch command that indicates the TA value as selected. In some examples, the serving cell may select a more-recently acquired one of the UE-based TA value or the RACH-based TA value. And in some examples, the TA value is the RACH-based TA value, reported to the serving cell by the target cell, and included in the cell-switch command.

Also, similar to the case of selection of the TA value at the UE 208, in some examples, the serving cell (S-DU 212A) may be configured to select the TA value based on one or more timers at the serving cell that mark acquisition of either or both of the UE-based TA value or the RACH-based TA value. Likewise, in some examples, the serving cell may be configured to select the TA value based on the one or more beams on which the UE-based TA value and the RACH-based TA value are acquired. In some further examples in which one or more uplink grants are provided to the UE, the TA value may be selected based on the one or more uplink grants, and the one or more beams.

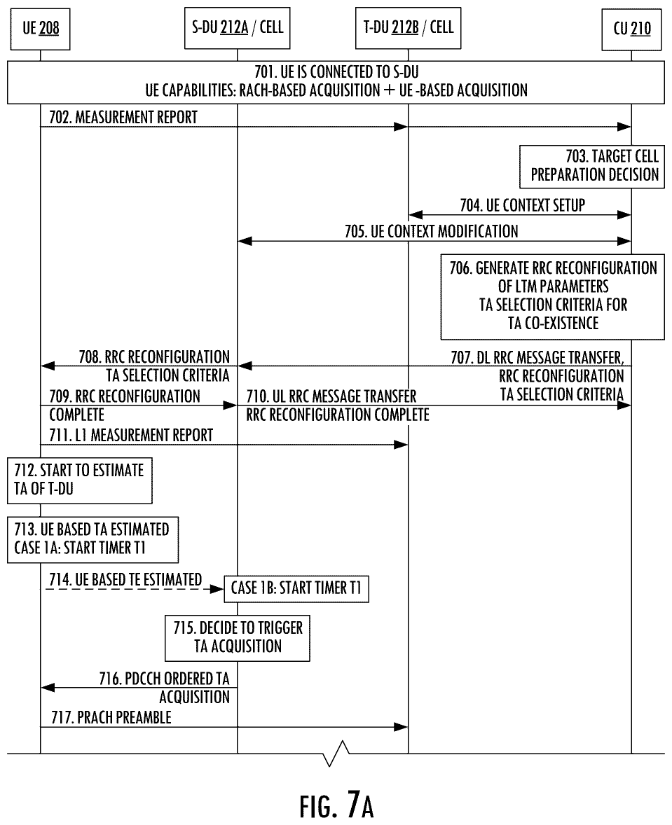

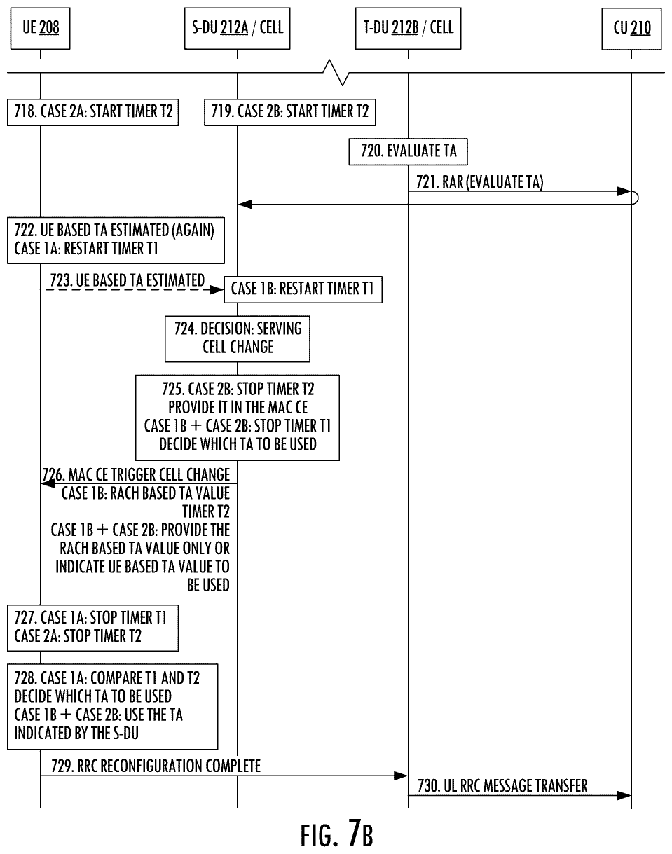

FIGS. 7A and 7B illustrate a signaling chart for an LTM procedure in a CU-DU split architecture, according to some example implementations. The signaling chart is shown for intra-CU inter-DU mobility in which one CU 210 controls multiple DUs 212 including the S-DU 212A and T-DU 212B, although it should be understood that example implementations are equally applicable to inter-CU inter-DU mobility in which different CUs control the S-DU and T-DU.

As shown at step 701, the UE is connected to the S-DU 212A/cell (serving cell), and the UE is capable of both RACH-based acquisition (at times referred to as RACH-based early TA acquisition) and UE-based acquisition (at times referred to as UE-based TA estimate). This capability of the UE is known to the network (e.g., CU 210), such as part of the UE capabilities.

As shown at step 702, the UE 208 transmits a measurement report to the CU 210 via the S-DU 212A, and the CU at step 703 decides to prepare one or more candidate target cells (including T-DU 212B/cell) for LTM. As shown at steps 704 and 705, the CU proceeds with the UE context setup/modification procedures. At step 706, the CU generates RRC reconfiguration(s) for the configured candidate target cell(s); and at steps 707 and 708, the transmits the RRC configuration(s) to the UE 208.

At steps 706, 707 and 708, the CU 210 also configures the UE 208 with selection criteria for the TA of a target cell (e.g., T-DU 212B/cell), acquired by UE-based acquisition and RACH-based acquisition. The CU may also at step 707 configure the serving cell (S-DU 212A/cell) with the selection criteria. The selection criteria for the TA may at times be referred to as TA selection criteria for the TA coexistence, which may be configured to the UE when both TA values are available at a time of cell switch.

In one example, the network (e.g., CU 210) may configure the UE 208 to select a more-recently acquired one of the UE-based TA value or the RACH-based TA value. In another example, the network may configure the UE to apply a time difference threshold to the times of acquisition of the TA values, which may be determined by the network based at least on a quality of a UE-based TA estimator of the UE, and/or a quality of synchronization between the serving and target cells. For example, if t₁ represents an acquisition time of the latest UE-based TA value, and t₂ represents an acquisition time of the latest RACH-based TA value, the time difference threshold δ may be applied to indicate selection of the UE-based TA value when t₁−t₂>δ, which indicates the UE-based TA value is at least δ seconds more “fresh” than the RACH-based TA value. The RACH-based TA value should otherwise be selected when t₁−t₂≤δ.

In another example, the network may configure the UE to apply one of the TA values for a first UL transmission (e.g., RACH-based TA value); and if the first UL transmission fails, apply the other of the TA values (e.g., (e.g., UE-based TA value) for a retransmission or reattempt, such as in cases in which a difference in the TA values is greater than a threshold. And in some examples in which the difference is greater than a threshold, the UE may be configured to send an indication to the network, which may be used to trigger a reacquisition of either or both of the values.

In another example, selection of the TA value may follow the beam of the target cell (e.g., T-DU 212B/cell) selected for the cell switch (e.g., UL transmission). In some of these examples in which the TA values are acquired on different beams of the target cell, the UE may apply the one that aligns with the beam identified in a cell switch command from the serving cell (S-DU 212A/cell).

At steps 709 and 710, the UE 208 sends a RRC reconfiguration complete to the CU 210 via the S-DU 212A/cell. The UE then at step 711 starts reporting L1 measurements. Only one L1 measurement reporting is shown, but it should be understood that the UE may transmit multiple L1 measurement reports to the S-DU 212A.

The UE 208 at step 712 initiates a procedure to acquire or otherwise estimate the UE-based TA value of the T-DU 212B/cell according to the UE-based acquisition scheme, although the UE may more generally acquire the UE-based TA value of one or more of the candidate target cell(s) (including the T-DU/cell). This procedure may be triggered by the S-DU 212A (e.g., based on an L1 measurement report), such as by a MAC-CE. In other examples, the procedure may be triggered by the UE, such as by monitoring relevant reference signal measurements, and later perform the UE-based acquisition when a given condition is met or another trigger mechanism is activated. In a more particular example, the UE may be configured to initiate UE-based acquisition at step 716 when the UE receives a TA-acquisition command, such as a physical downlink control channel (PDCCH) order, for RACH-based acquisition) from the serving cell (S-DU 212A/cell). The UE may be configured to apply/use a TCI state (beam) indicated in the TA-acquisition command for both RACH-based and UE-based acquisition.

At step 713, the UE 208 successfully evaluates the UE-based TA value for the first time. As configured at step 708, the UE starts a first coexistence timer, T1, that marks acquisition of the UE-based TA value (case 1A). In some examples, the UE at step 714 reports the UE-based TA value to the S-DU 212A (as soon as it is estimated), and the S-DU starts the first coexistence timer T1 at the S-DU side (case 1B).

At step 715, the S-DU 212A/cell decides to trigger the TA acquisition of the target cell (e.g., T-DU 212B/cell). The S-DU transmits a TA-acquisition command, which the UE receives at step 716 to trigger the UE to transmit a random access preamble to the target cell that is configured to acquire a RACH-based TA value. The UE then at step 717 sends a PRACH preamble to the T-DU as instructed by the S-DU/cell.

At step 718, the UE 208 starts a second coexistence timer, T2, that marks acquisition of the RACH-based TA value. In one example, the UE starts T2 after the UE sends the PRACH preamble towards the T-DU 212B/cell (based on the configuration from step 708) (case 2A). In another example, the S-DU 212A at step 719 starts the second coexistence timer T2, after transmitting the TA-acquisition command, which may be based on the random access occasion to be used by the UE. In this regard, the timing of the preamble transmission by the UE may be known by the S-DU (case 2B). In yet another example, the timer(s) (at the UE-side or network side) may be triggered (or continue) if a difference between the UE-based TA value and the RACH-based TA value exceeds a certain threshold.

At steps 720 and 721, the T-DU 212B/cell evaluates or otherwise determines a TA between the UE 208 and the T-DU/cell, i.e., the RACH-based TA value, and transmits the RACH-based TA value to the S-DU 212A/cell via CU 210, such as in a RAR.

As shown at step 722, the UE 208 may perform the UE-based acquisition several times, based on its configuration and validity of the UE-based TA value. In the case that the UE performs/re-evaluate the UE-based TA value (for the same cell), the UE restarts the first coexistence timer T1 (again, case 1A where UE starts T1). In another example, the UE 208 may reset/restart first coexistence timer T1 once there is an update/change in target-cell beam (i.e., the beam has been configured for UE-based acquisition).

Similar to before in step 714, in another example, the UE 208 re-evaluates and resends the UE-based TA value to the S-DU 212A, and the S-DU restarts the first coexistence timer T1 (again, case 1B where S-DU starts T1). It should be noted, however, that steps 722 and 723 may not be performed in every LTM procedure. Repetition of the UE-based acquisition is shown to illustrate UE behavior and the timer handling in examples in which the LTM procedure includes those steps.

At step 724, the serving cell (S-DU 212A/cell) decides to trigger a cell change towards T-DU 212B/cell.

In case 2B in which the second coexistence timer T2 is started by the S-DU 212A (referring to step 719), the S-DU at step 725 stops the second coexistence timer T2, and prepares the cell-switch command (MAC CE) to the UE 208. In another example, in case 1B in which the first coexistence timer T1 is started by the S-DU (independent of case 2B), the S-DU stops the first coexistence timer T1. If both T1 and T2 are available at the S-DU side (both case 1B and case 2B are adopted), the S-DU selects the UE-based TA value and the RACH-based TA value to be used by the UE, based on the configuration from the CU 210. In some examples, as described above, the selection criteria may be based on the values of T1 and T2 such that, for example, the UE-based TA value is selected when T1 is smaller than T2; otherwise, the RACH-based TA value is selected when T1 is greater than (or equal to) T2.

As shown at step 726, the serving cell (S-DU 212A/cell) sends the cell-switch command (MAC-CE) to trigger an LTM cell change. In case 1B where the S-DU has only T2, the S-DU shares the T2 value along with the RACH-based TA value. In another example in which both case 1B and 2B are adopted, and both T1 and T2 are available at the S-DU, the S-DU either indicates selection of the RACH-based TA value for use by the UE, and provides the RACH-based TA value; or the S-DU indicates selection of the UE-based TA value for use by the UE 208 (depending on the decision at step 725).

At step 727, in either or both case 1A or case 2A, the UE 208 stops any T1 and/or T2 if already running on the UE side, upon reception of the cell-change command.

In case 1A (irrespective of case 2A and 2B), the UE 208 has both T1 and T2 values, and the UE at step 728 selects the UE-based TA value and the RACH-based TA value to use based on the configuration from the CU 210. In some examples, (similar to step 725), the selection criteria may be based on the T1 and T2 values such that, for example, the UE-based TA value is selected when T1 is smaller than T2; and otherwise, the RACH-based TA value is selected when T1 is greater than (or equal to) T2.

In case 1B along with case 2B (where both T1 and T2 are at the S-DU 212A), the UE 208 either uses the RACH-based TA value (provided in the cell-switch command) or the UE-based TA value, as indicated by the S-DU in the cell-switch command.

At steps 729 and 730, the UE 208, T-DU 212B/cell and CU 210 complete the LTM procedure. The UE can be configured to stop the timer once it moves to the target-cell, such as when the UE receives any DL message from the T-DU/cell (now the serving cell), receives a TA update command, or successfully transmits the RRC complete message.

As indicated above, the coexistence of both the UE-based and RACH-based acquisition schemes may create a misalignment between the UL Grant and TCI state that is provided to the UE 208 and the TA value that is obtained on a beam. In some examples, then, the network (e.g., CU 210) may configure the UE to perform UE-based acquisition on a particular beam of the T-DU 212B/cell. In this regard, when the UE-based TA value and the RACH-based TA value are acquired on a common beam of the target cell, the UE may be allowed to use either of the TA values; otherwise, the UE may be limited to the RACH-based TA value (given by the S-DU 212A) when the TA values are acquired on different beams.

In other examples, the S-DU 212A/cell may acquire multiple UL grants and TCI states, one UL grant and TCI state per beam of multiple beams of the T-DU 212B/cell. In these examples, the CU 210 may configure the T-DU to provide multiple dynamic UL grants after the cell switch. These multiple UL grants may correspond to multiple beams, e.g., beams in proximity of the RACH beam (i.e., neighbor beams). After receiving the cell switch command, the UE 208 may monitors the PDCCH search space of the T-DU 212B/cell (which has been configured in the candidate target cell RRC configuration). The UE may identify the available UL grants and use the UL grant associated with the beam used to acquire the UE-based TA value (provided the beam is different from the beam used to acquire the RACH-based TA estimate, and the UE selects the UE-based TA value). The UE may here have more flexibility on usage of available TA, albeit at the expense of more resource reservation on UL grants from the T-DU/cell.

In yet other examples, a dynamic UL grant may be used. As shown in FIGS. 7A and 7B, the UE 208 may indicate to the network (e.g., S-DU 212A/cell) whether it performed a UE-based acquisition, and report the UE-based TA value. The UE may also report the beam on which the UE acquired the UE-based TA value. In some examples, then, this reporting of the beam may be conditioned on configured reporting criteria, which may be part of the configuration of the UE. In another example, the UE may be configured to acquire the UE-based TA value on a beam different from the RACH-based TA value.

In some of these other examples, the S-DU 212A/cell may receive an indication from the UE 208 that the UE-based and RACH based beams are different. The S-DU/cell may then message the CU 210 (and thereby the T-DU 212B/cell) to provide a particular UL grant, depending on which entity handles T1 and T2 (UE or S-DU), and which of the TA values is selected. In particular, the S-DU/cell may message the CU (and thereby T-DU/cell) to provide (1) a UL grant only for the beam that the UE has used for UE-based TA value, (2) a UL grant only for the beam used for RACH-based acquisition, or (3) UL grants for both beams (UE-based and RACH-based). The UE in these examples may still be flexible to use either the RACH-based TA value or the UE-based TA value, and the UL grant resources may be reserved only if needed at the expense of extra signaling and delay in the UL grant acquisition between S-DU, CU and T-DU.

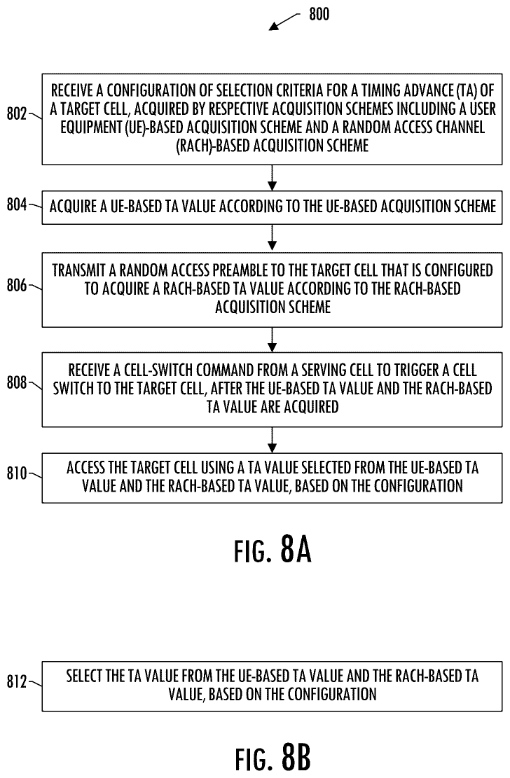

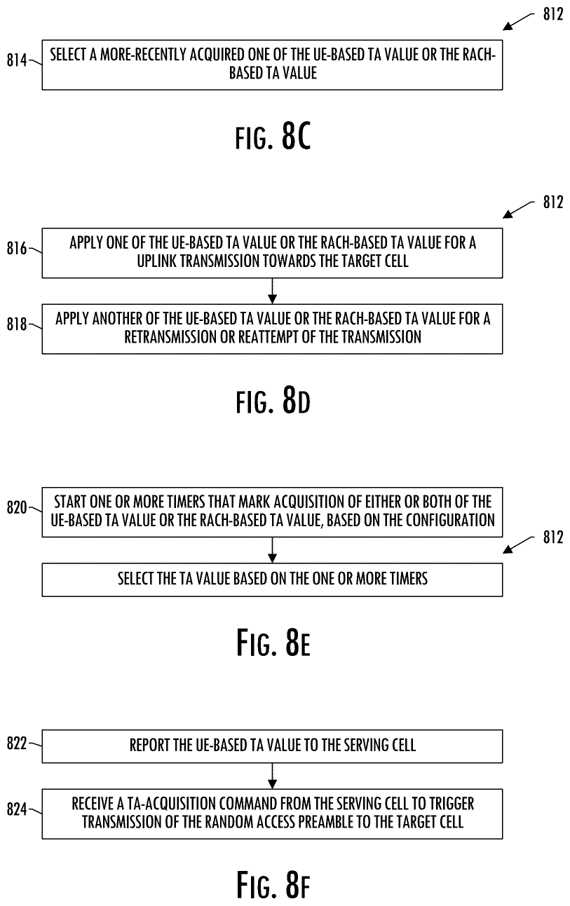

FIGS. 8A-8F are flowcharts illustrating various steps in a method 800 that may be implemented by a user equipment, according to various example implementations. The method includes receiving a configuration of selection criteria for a timing advance (TA) of a target cell, acquired by respective acquisition schemes including a user equipment (UE)-based acquisition scheme and a random access channel (RACH)-based acquisition scheme, as shown at block 802 of FIG. 8A. The method includes acquiring a UE-based TA value according to the UE-based acquisition scheme, as shown at block 804. The method includes transmitting a random access preamble to the target cell that is configured to acquire a RACH-based TA value according to the RACH-based acquisition scheme, as shown at block 806.

The method 800 includes receiving a cell-switch command from a serving cell to trigger a cell switch to the target cell, after the UE-based TA value and the RACH-based TA value are acquired, as shown at block 808. And the method includes accessing the target cell using a TA value selected from the UE-based TA value and the RACH-based TA value, based on the configuration, as shown at block 810.

In some examples, the cell-switch command includes the RACH-based TA value, reported to the serving cell by the target cell. In some of these examples, the method further includes selecting the TA value from the UE-based TA value and the RACH-based TA value, based on the configuration, as shown at block 812 of FIG. 8B.

In some examples, selecting the TA value at block 812 includes selecting a more-recently acquired one of the UE-based TA value or the RACH-based TA value, as shown at block 814 of FIG. 8C.

In some examples, selecting the TA value at block 812 includes applying one of the UE-based TA value or the RACH-based TA value for a uplink transmission towards the target cell, as shown at block 816 of FIG. 8D. In some of these examples, based on a failure of the uplink transmission, the method includes applying another of the UE-based TA value or the RACH-based TA value for a retransmission or reattempt of the transmission, as shown at block 818.

In some examples, the method 800 further includes starting one or more timers that mark acquisition of either or both of the UE-based TA value or the RACH-based TA value, based on the configuration, as shown at block 820 of FIG. 8E. In some of these examples, the TA value is selected at block 812 based on the one or more timers.

In some examples, the UE-based TA value and the RACH-based TA value are acquired on one or more beams of the target cell. In some of these examples, the TA value is selected at block 812 based on the one or more beams.

In some further examples, the TA value selected is the UE-based TA value when the UE-based TA value and the RACH-based TA value are acquired on a common beam of the target cell, and the RACH-based TA value when the UE-based TA value and the RACH-based TA value are acquired on different beams of the target cell.

In some examples, one or more uplink grants are provided for accessing the target cell, and the TA value is selected at block 812 based on the one or more uplink grants, and the one or more beams on which the UE-based TA value and the RACH-based TA value are acquired.

In some examples, the TA value is one of the UE-based TA value or the RACH-based TA value, and the target cell is accessed at block 810 using the TA value and one of the one or more uplink grants associated with a beam on which the one of the UE-based TA value or the RACH-based TA value is acquired.

In some examples, the UE-based TA value and the RACH-based TA value are acquired on different beams of the target cell, and the method further comprises reporting a beam of the one or more beams on which the UE-based TA value is acquired, the beam reported to the serving cell that is configured to provide an uplink grant associated with the beam.

In some examples, the method 800 further includes reporting the UE-based TA value to the serving cell, as shown at block 822 of FIG. 8F. The method includes receiving a TA-acquisition command from the serving cell to trigger transmission of the random access preamble to the target cell, as shown at block 824. And in some of these examples, the TA value is selected at the serving cell, and the cell-switch command indicates the TA value as selected.

In some examples, the TA value is the RACH-based TA value, reported to the serving cell by the target cell, and included in the cell-switch command.

In some examples, the TA value is selected at the serving cell based on one or more timers at the serving cell that mark acquisition of either or both of the UE-based TA value or the RACH-based TA value.

In some examples, the UE-based TA value and the RACH-based TA value are acquired on one or more beams of the target cell, and the TA value is selected at the serving cell based on the one or more beams.

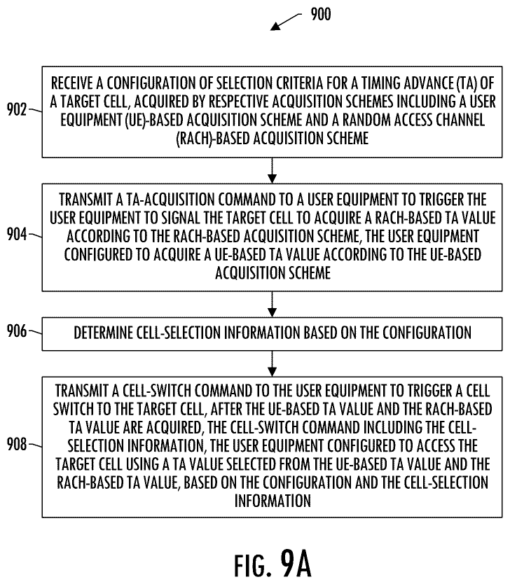

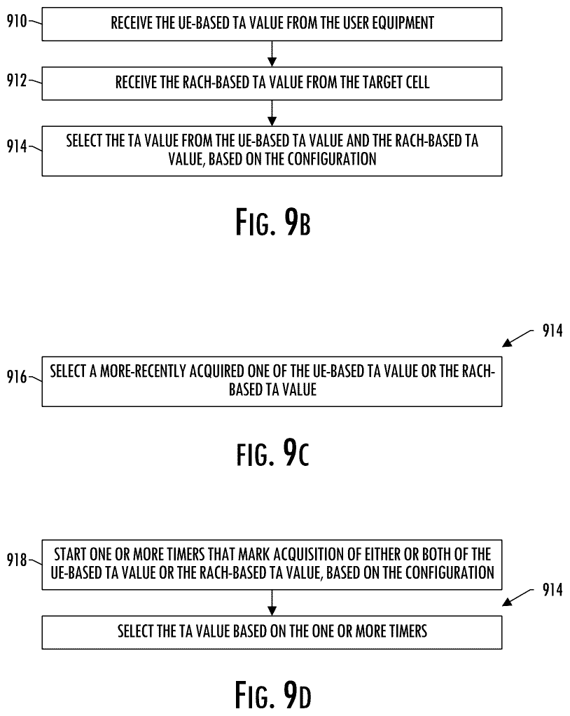

FIGS. 9A-9D are flowcharts illustrating various steps in a method 900 that may be implemented at a serving cell (e.g., a source DU), according to various example implementations. The method includes receiving a configuration of selection criteria for a timing advance (TA) of a target cell, acquired by respective acquisition schemes including a user equipment (UE)-based acquisition scheme and a random access channel (RACH)-based acquisition scheme, as shown at block 902 of FIG. 9A. The method includes transmitting a TA-acquisition command to a user equipment to trigger the user equipment to transmit a random access preamble to the target cell that is configured to acquire a RACH-based TA value according to the RACH-based acquisition scheme, as shown at block 904. The user equipment is configured to acquire a UE-based TA value according to the UE-based acquisition scheme.

The method 900 includes determining cell-selection information based on the configuration, as shown at block 906. And the method includes transmitting a cell-switch command to the user equipment to trigger a cell switch to the target cell, after the UE-based TA value and the RACH-based TA value are acquired, as shown at block 908. The cell-switch command includes the cell-selection information, and the user equipment is configured to access the target cell using a TA value selected from the UE-based TA value and the RACH-based TA value, based on the configuration and the cell-selection information.

In some examples, the cell-selection information includes the RACH-based TA value, reported by the target cell, and included in the cell-switch command to the user equipment that is configured to select the TA value from the UE-based TA value and the RACH-based TA value.

In some examples, the TA value is selected at the user equipment based on one or more timers that mark acquisition of either or both of the UE-based TA value or the RACH-based TA value.

In some examples, the UE-based TA value and the RACH-based TA value are acquired on one or more beams of the target cell, and the TA value is selected at the user equipment based on the one or more beams.

In some examples, the method 900 further includes receiving the UE-based TA value from the user equipment, as shown at block 910 of FIG. 9B. In some of these examples, the method includes receiving the RACH-based TA value from the target cell, as shown at block 912. And the method includes selecting the TA value from the UE-based TA value and the RACH-based TA value, based on the configuration, as shown at block 914. And the cell-selection information in the cell-switch command indicates the TA value as selected.

In some examples, selecting the TA value at block 914 includes selecting a more-recently acquired one of the UE-based TA value or the RACH-based TA value, as shown at block 916 of FIG. 9C.

In some examples, the TA value is the RACH-based TA value, reported by the target cell, and included in the cell-switch command.

In some examples, the method 900 further includes starting one or more timers that mark acquisition of either or both of the UE-based TA value or the RACH-based TA value, based on the configuration, as shown at block 918 of FIG. 9D. And in some of these examples, the TA value is selected at block 914 based on the one or more timers.

In some examples, the UE-based TA value and the RACH-based TA value are acquired on one or more beams of the target cell. In some of these examples, the TA value is selected at block 914 based on the one or more beams.

In some examples, the TA value selected is the UE-based TA value when the UE-based TA value and the RACH-based TA value are acquired on a common beam of the target cell, and the RACH-based TA value when the UE-based TA value and the RACH-based TA value are acquired on different beams of the target cell.

In some examples, one or more uplink grants are provided the user equipment to access the target cell, and the TA value is selected at block 914 based on the one or more uplink grants, and the one or more beams on which the UE-based TA value and the RACH-based TA value are acquired.

In some examples, the UE-based TA value and the RACH-based TA value are acquired on different beams of the target cell. In some of these examples, the method further comprises receiving from the user equipment an indication of a beam of the one or more beams on which the UE-based TA value is acquired. And the method further comprises requesting that the target cell provide an uplink grant associated with the beam.

According to example implementations of the present disclosure, a telecommunications system 100 or PLMN 102, and its components such as a UE 110, gNB 206, UE 208, CU 210, DU 212, S-DU 212A and/or T-DU 212B, may be implemented by various means. Means for implementing the system and its components may include hardware, firmware, software, or combinations thereof. In some examples, one or more apparatuses may be configured to function as or otherwise implement the system and its components shown and described herein. In examples involving more than one apparatus, the respective apparatuses may be connected to or otherwise in communication with one another in a number of different manners, such as directly or indirectly via a wired or wireless network or the like.

According to some example implementations, at least some of the method 800 described with respect to FIGS. 8A-8F may be carried out by an apparatus comprising means for performing functions corresponding steps of the method. Similarly, at least some of the method 900 described with respect to FIGS. 9A-9D may be carried out by an apparatus comprising means for performing functions corresponding steps of the method. Examples of a suitable apparatus may include a gNB (e.g., gNB-DU, gNB-CU), ng-eNB or any suitable apparatus, such as a server, host or node. Other examples of a suitable apparatus may include a user equipment, user device, user terminal or the like.

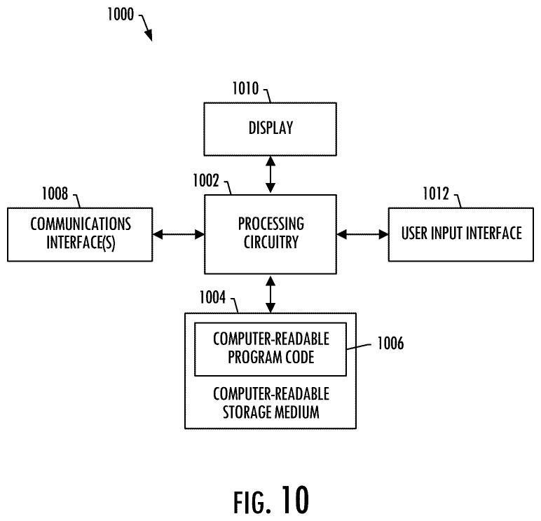

FIG. 10 illustrates an apparatus 1000 in which means for performing various functions includes hardware, alone or under direction of one or more computer programs from a computer-readable storage medium, such as computer memory (or more simply “memory”), according to some example implementations of the present disclosure. The apparatus may include one or more of each of a number of components such as, for example, processing circuitry 1002 connected to computer-readable storage medium 1004.

The processing circuitry 1002 may be composed of one or more processors alone or in combination with one or more computer-readable storage media. The processing circuitry is generally any piece of computer hardware that is capable of processing information such as, for example, data, computer programs and/or other suitable electronic information. The processing circuitry is composed of a collection of electronic circuits some of which may be packaged as an integrated circuit or multiple interconnected integrated circuits (an integrated circuit at times more commonly referred to as a “chip”). The processing circuitry may be configured to execute computer programs, which may be stored onboard the processing circuitry or otherwise stored in the computer-readable storage medium 1004 (of the same or another apparatus).

The processing circuitry 1002 may be a number of processors, a multi-core processor or some other type of processor, depending on the particular implementation. Further, the processing circuitry may be implemented using a number of heterogeneous processor systems in which a main processor is present with one or more secondary processors on a single chip. As another illustrative example, the processing circuitry may be a symmetric multi-processor system containing multiple processors of the same type. In yet another example, the processing circuitry may be embodied as or otherwise include one or more ASICs, FPGAs or the like. Thus, although the processing circuitry may be capable of executing a computer program to perform one or more functions, the processing circuitry of various examples may be capable of performing one or more functions without the aid of a computer program. In either instance, the processing circuitry may be appropriately programmed to perform functions or operations according to example implementations of the present disclosure.

The computer-readable storage medium 1004 is generally any piece of computer hardware that is capable of storing information such as, for example, data, computer programs (e.g., computer-readable program code 1006) and/or other suitable information either on a temporary basis and/or a permanent basis. The computer-readable storage medium may include volatile and/or non-volatile memory, and may be fixed or removable. Examples of suitable memory include recording media, random access memory (RAM), read-only memory (ROM), a hard drive, a flash memory, a thumb drive, a removable computer diskette, an optical disk or some combination thereof.

The computer-readable storage medium 1004 is a non-transitory device capable of storing information, and is distinguishable from a computer-readable transmission medium capable of carrying information from one location to another. Examples of suitable computer-readable transmission media comprise electronic carrier signals, telecommunications signals, software distribution packages, or some combination thereof. As used herein, the term “non-transitory” is a limitation of the medium itself (i.e., tangible, not a signal) as opposed to a limitation on data storage persistency (e.g., RAM versus ROM). A computer-readable medium as described herein generally refers to a computer-readable storage medium or computer-readable transmission medium. A computer-readable medium is any entity or device capable in which information, such as one or more computer programs or portions thereof, may be stored and carried.

In addition to the computer-readable storage medium 1004, the processing circuitry 1002 may also be connected to one or more interfaces for displaying, transmitting and/or receiving information. The interfaces may include a communications interface 1008 and/or one or more user interfaces. The communications interface may be configured to transmit and/or receive information, such as to and/or from other apparatus(es), network(s) or the like. The communications interface may be configured to transmit and/or receive information by physical (wired) and/or wireless communications links. Examples of suitable communication interfaces include a network interface controller (NIC), wireless NIC (WNIC) or the like.

In particular in the case of user equipment, user device, user terminal or the like, the user interfaces may include a display 1010 and/or one or more user input interfaces 1012. The display may be configured to present or otherwise display information to a user, suitable examples of which include a liquid crystal display (LCD), light-emitting diode (LED) display, organic LED (OLED) display, active-matrix OLED (AMOLED) or the like. The user input interfaces may be wired or wireless, and may be configured to receive information from a user into the apparatus, such as for processing, storage and/or display. Suitable examples of user input interfaces include a microphone, image or video capture device, keyboard or keypad, joystick, touch-sensitive surface (separate from or integrated into a touchscreen), biometric sensor or the like. The user interfaces may further include one or more interfaces for communicating with peripherals such as printers, scanners or the like.

Execution of the computer-readable program code 1006 by the processing circuitry 1002, or storage of the computer-readable program code in the computer-readable storage medium 1004, supports combinations of operations for implementing example implementations of the present disclosure. In this manner, an apparatus 1000 may comprise at least one processing circuitry and at least one computer-readable storage medium coupled to the at least one processing circuitry, where the at least one processing circuitry is configured to execute computer-readable program code stored in the at least one computer-readable storage medium. It will also be understood that one or more functions, and combinations of functions, may be implemented by special purpose hardware-based computer systems and/or processing circuitry which perform the specified functions, or combinations of special purpose hardware and program code instructions.

Some example implementations of the present disclosure may also be carried out in the form of a computer process defined by one or more computer programs or portions thereof. Example implementations of the present disclosure may be carried out by executing at least one portion of a computer program comprising computer-readable program code. The computer program may be in source code form, object code form, or in some intermediate form. The computer program may be stored in a computer-readable medium that is readable by a computer, processing circuitry or other suitable apparatus. As indicated above, for example, the computer program may be stored in a computer-readable storage medium. Additionally or alternatively, for example, the computer program may be stored in a computer-readable transmission medium. The coding of software for carrying out example implementations of the present disclosure is well within the scope of a person of ordinary skill in the art.

As will be appreciated, any suitable computer-readable program code may be loaded onto a computer, a processing circuitry or other programmable apparatus from a computer-readable medium (e.g., computer-readable storage medium, computer-readable transmission medium) to produce a particular machine, such that the particular machine becomes a means for implementing the functions specified herein. The computer-readable program code may also be stored in a computer-readable medium that can direct a computer, a processing circuitry or other programmable apparatus to function in a particular manner to thereby generate a particular machine or particular article of manufacture. In some examples, the computer-readable program code stored in the computer-readable medium may produce an article of manufacture, where the article of manufacture becomes a means for implementing functions described herein. The computer-readable program code may be retrieved from a computer-readable medium and loaded into a computer, processing circuitry or other programmable apparatus to configure the computer, processing circuitry or other programmable apparatus to execute operations to be performed on or by the computer, processing circuitry or other programmable apparatus.

Retrieval, loading and execution of computer-readable program code comprising program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processing circuitry or other programmable apparatus provide operations for implementing functions described herein.

As explained above and reiterated below, the present disclosure includes, without limitation, the following example implementations.

Clause 1. An apparatus comprising: at least one memory configured to store computer-readable program code; and at least one processing circuitry configured to access the at least one memory, and execute the computer-readable program code to cause the apparatus to at least: receive a configuration of selection criteria for a timing advance (TA) of a target cell, acquired by respective acquisition schemes including a user equipment (UE)-based acquisition scheme and a random access channel (RACH)-based acquisition scheme; acquire a UE-based TA value according to the UE-based acquisition scheme; transmit a random access preamble to the target cell that is configured to acquire a RACH-based TA value according to the RACH-based acquisition scheme; receive a cell-switch command from a serving cell to trigger a cell switch to the target cell, after the UE-based TA value and the RACH-based TA value are acquired; and access the target cell using a TA value selected from the UE-based TA value and the RACH-based TA value, based on the configuration.

Clause 2. The apparatus of clause 1, wherein the cell-switch command includes the RACH-based TA value, reported to the serving cell by the target cell, and wherein the at least one processing circuitry is configured to execute the computer-readable program code to cause the apparatus to further select the TA value from the UE-based TA value and the RACH-based TA value, based on the configuration.

Clause 3. The apparatus of clause 2, wherein the apparatus caused to select the TA value includes the apparatus caused to select a more-recently acquired one of the UE-based TA value or the RACH-based TA value.

Clause 4. The apparatus of clause 2 or clause 3, wherein the apparatus caused to select the TA value includes the apparatus caused to: apply one of the UE-based TA value or the RACH-based TA value for a uplink transmission towards the target cell; and based on a failure of the uplink transmission, apply another of the UE-based TA value or the RACH-based TA value for a retransmission or reattempt of the transmission.

Clause 5. The apparatus of any of clauses 2 to 4, wherein the at least one processing circuitry is configured to execute the computer-readable program code to cause the apparatus to further start one or more timers that mark acquisition of either or both of the UE-based TA value or the RACH-based TA value, based on the configuration, and wherein the TA value is selected based on the one or more timers.

Clause 6. The apparatus of any of clauses 2 to 5, wherein the UE-based TA value and the RACH-based TA value are acquired on one or more beams of the target cell, and wherein the TA value is selected based on the one or more beams.

Clause 7. The apparatus of clause 6, wherein the TA value selected is the UE-based TA value when the UE-based TA value and the RACH-based TA value are acquired on a common beam of the target cell, and the RACH-based TA value when the UE-based TA value and the RACH-based TA value are acquired on different beams of the target cell.

Clause 8. The apparatus of clause 6 or clause 7, wherein one or more uplink grants are provided for accessing the target cell, and the TA value is selected based on the one or more uplink grants, and the one or more beams on which the UE-based TA value and the RACH-based TA value are acquired.

Clause 9. The apparatus of clause 8, wherein the TA value is one of the UE-based TA value or the RACH-based TA value, and the target cell is accessed using the TA value and one of the one or more uplink grants associated with a beam on which the one of the UE-based TA value or the RACH-based TA value is acquired.

Clause 10. The apparatus of clause 8 or clause 9, wherein the UE-based TA value and the RACH-based TA value are acquired on different beams of the target cell, and the at least one processing circuitry is configured to execute the computer-readable program code to cause the apparatus to further report a beam of the one or more beams on which the UE-based TA value is acquired, the beam reported to the serving cell that is configured to provide an uplink grant associated with the beam.

Clause 11. The apparatus of any of clauses 1 to 10, wherein the at least one processing circuitry is configured to execute the computer-readable program code to cause the apparatus to further at least: report the UE-based TA value to the serving cell; and receive a TA-acquisition command from the serving cell to trigger transmission of the random access preamble to the target cell, and wherein the TA value is selected at the serving cell, and the cell-switch command indicates the TA value as selected.

Clause 12. An apparatus comprising: means for receiving a configuration of selection criteria for a timing advance (TA) of a target cell, acquired by respective acquisition schemes including an user equipment (UE)-based acquisition scheme and a random access channel (RACH)-based acquisition scheme; means for acquiring a UE-based TA value according to the UE-based acquisition scheme; means for transmitting a random access preamble to the target cell that is configured to acquire a RACH-based TA value according to the RACH-based acquisition scheme; means for receiving a cell-switch command from a serving cell to trigger a cell switch to the target cell, after the UE-based TA value and the RACH-based TA value are acquired; and means for accessing the target cell using a TA value selected from the UE-based TA value and the RACH-based TA value, based on the configuration.

Clause 13. The apparatus of clause 12, wherein the cell-switch command includes the RACH-based TA value, reported to the serving cell by the target cell, and wherein the apparatus further comprises means for selecting the TA value from the UE-based TA value and the RACH-based TA value, based on the configuration.

Clause 14. The apparatus of clause 13, wherein the means for selecting the TA includes second selecting means for selecting a more-recently acquired one of the UE-based TA value or the RACH-based TA value.

Clause 15. The apparatus of clause 13 or clause 14, wherein the means for selecting the TA includes: means for applying one of the UE-based TA value or the RACH-based TA value for an uplink transmission towards the target cell; and based on a failure of the uplink transmission, means for applying another of the UE-based TA value or the RACH-based TA value for a retransmission or reattempt of the transmission.

Clause 16. The apparatus of any of clauses 13 to 15, wherein the apparatus further comprises means for starting one or more timers that mark acquisition of either or both of the UE-based TA value or the RACH-based TA value, based on the configuration, and wherein the TA value is selected based on the one or more timers.

Clause 17. The apparatus of any of clauses 13 to 16, wherein the UE-based TA value and the RACH-based TA value are acquired on one or more beams of the target cell, and wherein the TA value is selected based on the one or more beams.

Clause 18. The apparatus of clause 17, wherein the TA value selected is the UE-based TA value when the UE-based TA value and the RACH-based TA value are acquired on a common beam of the target cell, and the RACH-based TA value when the UE-based TA value and the RACH-based TA value are acquired on different beams of the target cell.

Clause 19. The apparatus of clause 17 or clause 18, wherein one or more uplink grants are provided for accessing the target cell, and the TA value is selected based on the one or more uplink grants, and the one or more beams on which the UE-based TA value and the RACH-based TA value are acquired.

Clause 20. The apparatus of clause 19, wherein the TA value is one of the UE-based TA value or the RACH-based TA value, and the target cell is accessed using the TA value and one of the one or more uplink grants associated with a beam on which the one of the UE-based TA value or the RACH-based TA value is acquired.

Clause 21. The apparatus of clause 19 or clause 20, wherein the UE-based TA value and the RACH-based TA value are acquired on different beams of the target cell, and the at least one processing circuitry is configured to execute the computer-readable program code to cause the apparatus to further report a beam of the one or more beams on which the UE-based TA value is acquired, the beam reported to the serving cell that is configured to provide an uplink grant associated with the beam.

Clause 22. The apparatus of any of clauses 12 to 21, wherein the apparatus further comprises: means for reporting the UE-based TA value to the serving cell; and means for receiving a TA-acquisition command from the serving cell to trigger transmission of the random access preamble to the target cell, and wherein the TA value is selected at the serving cell, and the cell-switch command indicates the TA value as selected.

Clause 23. A method comprising: receiving a configuration of selection criteria for a timing advance (TA) of a target cell, acquired by respective acquisition schemes including a user equipment (UE)-based acquisition scheme and a random access channel (RACH)-based acquisition scheme; acquiring a UE-based TA value according to the UE-based acquisition scheme; transmitting a random access preamble to the target cell that is configured to acquire a RACH-based TA value according to the RACH-based acquisition scheme; receiving a cell-switch command from a serving cell to trigger a cell switch to the target cell, after the UE-based TA value and the RACH-based TA value are acquired; and accessing the target cell using a TA value selected from the UE-based TA value and the RACH-based TA value, based on the configuration.

Clause 24. The method of clause 23, wherein the cell-switch command includes the RACH-based TA value, reported to the serving cell by the target cell, and wherein the method further comprises selecting the TA value from the UE-based TA value and the RACH-based TA value, based on the configuration.

Clause 25. The method of clause 24, wherein selecting the TA value includes selecting a more-recently acquired one of the UE-based TA value or the RACH-based TA value.

Clause 26. The method of clause 24 or clause 25, wherein selecting the TA value includes: applying one of the UE-based TA value or the RACH-based TA value for a uplink transmission towards the target cell; and based on a failure of the uplink transmission, applying another of the UE-based TA value or the RACH-based TA value for a retransmission or reattempt of the transmission.

Clause 27. The method of any of clauses 24 to 26, wherein the method further comprises starting one or more timers that mark acquisition of either or both of the UE-based TA value or the RACH-based TA value, based on the configuration, and wherein the TA value is selected based on the one or more timers.

Clause 28. The method of any of clauses 24 to 27, wherein the UE-based TA value and the RACH-based TA value are acquired on one or more beams of the target cell, and wherein the TA value is selected based on the one or more beams.

Clause 29. The method of clause 28, wherein the TA value selected is the UE-based TA value when the UE-based TA value and the RACH-based TA value are acquired on a common beam of the target cell, and the RACH-based TA value when the UE-based TA value and the RACH-based TA value are acquired on different beams of the target cell.

Clause 30. The method of clause 28 or clause 29, wherein one or more uplink grants are provided for accessing the target cell, and the TA value is selected based on the one or more uplink grants, and the one or more beams on which the UE-based TA value and the RACH-based TA value are acquired.

Clause 31. The method of clause 30, wherein the TA value is one of the UE-based TA value or the RACH-based TA value, and the target cell is accessed using the TA value and one of the one or more uplink grants associated with a beam on which the one of the UE-based TA value or the RACH-based TA value is acquired.

Clause 32. The method of clause 30 or clause 31, wherein the UE-based TA value and the RACH-based TA value are acquired on different beams of the target cell, and to the method further comprises reporting a beam of the one or more beams on which the UE-based TA value is acquired, the beam reported to the serving cell that is configured to provide an uplink grant associated with the beam.

Clause 33. The method of any of clauses 23 to 32, wherein the method further comprises: reporting the UE-based TA value to the serving cell; and receiving a TA-acquisition command from the serving cell to trigger transmission of the random access preamble to the target cell, and wherein the TA value is selected at the serving cell, and the cell-switch command indicates the TA value as selected.

Clause 34. A computer-readable storage medium that is non-transitory and has computer-readable program code stored therein that, in response to execution by at least one processing circuitry, causes an apparatus to at least: receive a configuration of selection criteria for a timing advance (TA) of a target cell, acquired by respective acquisition schemes including a user equipment (UE)-based acquisition scheme and a random access channel (RACH)-based acquisition scheme; acquire a UE-based TA value according to the UE-based acquisition scheme; transmit a random access preamble to the target cell that is configured to acquire a RACH-based TA value according to the RACH-based acquisition scheme; receive a cell-switch command from a serving cell to trigger a cell switch to the target cell, after the UE-based TA value and the RACH-based TA value are acquired; and access the target cell using a TA value selected from the UE-based TA value and the RACH-based TA value, based on the configuration.

Clause 35. The computer-readable storage medium of clause 34, wherein the cell-switch command includes the RACH-based TA value, reported to the serving cell by the target cell, and wherein the computer-readable storage medium has further computer-readable program code stored therein that, in response to execution by the at least one processing circuitry, causes the apparatus to further select the TA value from the UE-based TA value and the RACH-based TA value, based on the configuration.

Clause 36. The computer-readable storage medium of clause 35, wherein the apparatus caused to select the TA value includes the apparatus caused to select a more-recently acquired one of the UE-based TA value or the RACH-based TA value.

Clause 37. The computer-readable storage medium of clause 35 or clause 36, wherein the apparatus caused to select the TA value includes the apparatus caused to: apply one of the UE-based TA value or the RACH-based TA value for a uplink transmission towards the target cell; and based on a failure of the uplink transmission, apply another of the UE-based TA value or the RACH-based TA value for a retransmission or reattempt of the transmission.

Clause 38. The computer-readable storage medium of any of clauses 35 to 37, wherein the computer-readable storage medium has further computer-readable program code stored therein that, in response to execution by the at least one processing circuitry, causes the apparatus to further start one or more timers that mark acquisition of either or both of the UE-based TA value or the RACH-based TA value, based on the configuration, and wherein the TA value is selected based on the one or more timers.

Clause 39. The computer-readable storage medium of any of clauses 35 to 38, wherein the UE-based TA value and the RACH-based TA value are acquired on one or more beams of the target cell, and wherein the TA value is selected based on the one or more beams.

Clause 40. The computer-readable storage medium of clause 39, wherein the TA value selected is the UE-based TA value when the UE-based TA value and the RACH-based TA value are acquired on a common beam of the target cell, and the RACH-based TA value when the UE-based TA value and the RACH-based TA value are acquired on different beams of the target cell.

Clause 41. The computer-readable storage medium of clause 39 or clause 40, wherein one or more uplink grants are provided for accessing the target cell, and the TA value is selected based on the one or more uplink grants, and the one or more beams on which the UE-based TA value and the RACH-based TA value are acquired.

Clause 42. The computer-readable storage medium of clause 41, wherein the TA value is one of the UE-based TA value or the RACH-based TA value, and the target cell is accessed using the TA value and one of the one or more uplink grants associated with a beam on which the one of the UE-based TA value or the RACH-based TA value is acquired.

Clause 43. The computer-readable storage medium of clause 41 or clause 42, wherein the UE-based TA value and the RACH-based TA value are acquired on different beams of the target cell, and the at least one processing circuitry is configured to execute the computer-readable program code to cause the apparatus to further report a beam of the one or more beams on which the UE-based TA value is acquired, the beam reported to the serving cell that is configured to provide an uplink grant associated with the beam.

Clause 44. The computer-readable storage medium of any of clauses 34 to 43, wherein the computer-readable storage medium has further computer-readable program code stored therein that, in response to execution by the at least one processing circuitry, causes the apparatus to further at least: report the UE-based TA value to the serving cell; and receive a TA-acquisition command from the serving cell to trigger transmission of the random access preamble to the target cell, and wherein the TA value is selected at the serving cell, and the cell-switch command indicates the TA value as selected.

Clause 45. An apparatus comprising means for performing the method of any of clauses 23 to 33.

Clause 46. A computer-readable medium comprising computer-readable program code that, in response to execution by at least one processing circuitry, causes an apparatus to perform the method of any of clauses 23 to 33.

Clause 47. A computer-readable storage medium comprising computer-readable program code that, in response to execution by at least one processing circuitry, causes an apparatus to perform the method of any of clauses 23 to 33.

Clause 48. A computer program comprising computer-readable program code that, in response to execution by at least one processing circuitry, causes an apparatus to perform the method of any of clauses 23 to 33.

Clause 49. An apparatus comprising: at least one memory configured to store computer-readable program code; and at least one processing circuitry configured to access the at least one memory, and execute the computer-readable program code to cause the apparatus to at least: receive a configuration of selection criteria for a timing advance (TA) of a target cell, acquired by respective acquisition schemes including a user equipment (UE)-based acquisition scheme and a random access channel (RACH)-based acquisition scheme; transmit a TA-acquisition command to a user equipment to trigger the user equipment to transmit a random access preamble to the target cell that is configured to acquire a RACH-based TA value according to the RACH-based acquisition scheme, the user equipment configured to acquire a UE-based TA value according to the UE-based acquisition scheme; determine cell-selection information based on the configuration; and transmit a cell-switch command to the user equipment to trigger a cell switch to the target cell, after the UE-based TA value and the RACH-based TA value are acquired, the cell-switch command including the cell-selection information, the user equipment configured to access the target cell using a TA value selected from the UE-based TA value and the RACH-based TA value, based on the configuration and the cell-selection information.

Clause 50. The apparatus of clause 49, wherein the cell-selection information includes the RACH-based TA value, reported by the target cell, and included in the cell-switch command to the user equipment that is configured to select the TA value from the UE-based TA value and the RACH-based TA value.

Clause 51. The apparatus of clause 49 or clause 50, wherein the at least one processing circuitry is configured to execute the computer-readable program code to cause the apparatus to further at least: receive the UE-based TA value from the user equipment; receive the RACH-based TA value from the target cell; and select the TA value from the UE-based TA value and the RACH-based TA value, based on the configuration, and wherein the cell-selection information in the cell-switch command indicates the TA value as selected.

Clause 52. The apparatus of clause 51, wherein the apparatus caused to select the TA value includes the apparatus caused to select a more-recently acquired one of the UE-based TA value or the RACH-based TA value.

Clause 53. The apparatus of clause 51 or clause 52, wherein the TA value is the RACH-based TA value, reported by the target cell, and included in the cell-switch command.

Clause 54. The apparatus of any of clauses 51 to 53, wherein the at least one processing circuitry is configured to execute the computer-readable program code to cause the apparatus to further start one or more timers that mark acquisition of either or both of the UE-based TA value or the RACH-based TA value, based on the configuration, and wherein the TA value is selected based on the one or more timers.

Clause 55. The apparatus of any of clauses 51 to 54, wherein the UE-based TA value and the RACH-based TA value are acquired on one or more beams of the target cell, and wherein the TA value is selected based on the one or more beams.

Clause 56. The apparatus of clause 55, wherein the TA value selected is the UE-based TA value when the UE-based TA value and the RACH-based TA value are acquired on a common beam of the target cell, and the RACH-based TA value when the UE-based TA value and the RACH-based TA value are acquired on different beams of the target cell.

Clause 57. The apparatus of clause 55 or clause 56, wherein one or more uplink grants are provided the user equipment to access the target cell, and the TA value is selected based on the one or more uplink grants, and the one or more beams on which the UE-based TA value and the RACH-based TA value are acquired.

Clause 58. The apparatus of clause 57, wherein the UE-based TA value and the RACH-based TA value are acquired on different beams of the target cell, and the at least one processing circuitry is configured to execute the computer-readable program code to cause the apparatus to further: receive from the user equipment an indication of a beam of the one or more beams on which the UE-based TA value is acquired; and request that the target cell provide an uplink grant associated with the beam.

Clause 59. An apparatus comprising: means for receiving a configuration of selection criteria for a timing advance (TA) of a target cell, acquired by respective acquisition schemes including an user equipment (UE)-based acquisition scheme and a random access channel (RACH)-based acquisition scheme; means for transmitting a TA-acquisition command to an user equipment to trigger the user equipment to transmit a random access preamble to the target cell that is configured to acquire a RACH-based TA value according to the RACH-based acquisition scheme, the user equipment configured to acquire a UE-based TA value according to the UE-based acquisition scheme; means for determining cell-selection information based on the configuration; and means for transmitting a cell-switch command to the user equipment to trigger a cell switch to the target cell, after the UE-based TA value and the RACH-based TA value are acquired, the cell-switch command including the cell-selection information, the user equipment configured to access the target cell using a TA value selected from the UE-based TA value and the RACH-based TA value, based on the configuration and the cell-selection information.

Clause 60. The apparatus of clause 59, wherein the cell-selection information includes the RACH-based TA value, reported by the target cell, and included in the cell-switch command to the user equipment that is configured to select the TA value from the UE-based TA value and the RACH-based TA value.

Clause 61. The apparatus of clause 59 or clause 60, wherein the apparatus further comprises: means for receiving the UE-based TA value from the user equipment; means for receiving the RACH-based TA value from the target cell; and means for selecting the TA value from the UE-based TA value and the RACH-based TA value, based on the configuration, and wherein the cell-selection information in the cell-switch command indicates the TA value as selected.

Clause 62. The apparatus of clause 61, wherein the means for selecting the TA value includes means for selecting a more-recently acquired one of the UE-based TA value or the RACH-based TA value.

Clause 63. The apparatus of clause 61 or clause 62, wherein the TA value is the RACH-based TA value, reported by the target cell, and included in the cell-switch command.

Clause 64. The apparatus of any of clauses 61 to 63, wherein the apparatus further comprises means for starting one or more timers that mark acquisition of either or both of the UE-based TA value or the RACH-based TA value, based on the configuration, and wherein the TA value is selected based on the one or more timers.

Clause 65. The apparatus of any of clauses 61 to 64, wherein the UE-based TA value and the RACH-based TA value are acquired on one or more beams of the target cell, and wherein the TA value is selected based on the one or more beams.

Clause 66. The apparatus of clause 65, wherein the TA value selected is the UE-based TA value when the UE-based TA value and the RACH-based TA value are acquired on a common beam of the target cell, and the RACH-based TA value when the UE-based TA value and the RACH-based TA value are acquired on different beams of the target cell.

Clause 67. The apparatus of clause 65 or clause 66, wherein one or more uplink grants are provided the user equipment to access the target cell, and the TA value is selected based on the one or more uplink grants, and the one or more beams on which the UE-based TA value and the RACH-based TA value are acquired.

Clause 68. The apparatus of clause 67, wherein the UE-based TA value and the RACH-based TA value are acquired on different beams of the target cell, and the apparatus further comprises: means for receiving from the user equipment an indication of a beam of the one or more beams on which the UE-based TA value is acquired; and means for requesting that the target cell provide an uplink grant associated with the beam.

Clause 69. A method comprising: receiving a configuration of selection criteria for a timing advance (TA) of a target cell, acquired by respective acquisition schemes including a user equipment (UE)-based acquisition scheme and a random access channel (RACH)-based acquisition scheme; transmitting a TA-acquisition command to a user equipment to trigger the user equipment to transmit a random access preamble to the target cell that is configured to acquire a RACH-based TA value according to the RACH-based acquisition scheme, the user equipment configured to acquire a UE-based TA value according to the UE-based acquisition scheme; determining cell-selection information based on the configuration; and transmitting a cell-switch command to the user equipment to trigger a cell switch to the target cell, after the UE-based TA value and the RACH-based TA value are acquired, the cell-switch command including the cell-selection information, the user equipment configured to access the target cell using a TA value selected from the UE-based TA value and the RACH-based TA value, based on the configuration and the cell-selection information.

Clause 70. The method of clause 69, wherein the cell-selection information includes the RACH-based TA value, reported by the target cell, and included in the cell-switch command to the user equipment that is configured to select the TA value from the UE-based TA value and the RACH-based TA value.

Clause 71. The method of clause 69 or clause 70, wherein the method further comprises: receiving the UE-based TA value from the user equipment; receiving the RACH-based TA value from the target cell; and selecting the TA value from the UE-based TA value and the RACH-based TA value, based on the configuration, and wherein the cell-selection information in the cell-switch command indicates the TA value as selected.

Clause 72. The method of clause 71, wherein selecting the TA value includes selecting a more-recently acquired one of the UE-based TA value or the RACH-based TA value.

Clause 73. The method of clause 71 or clause 72, wherein the TA value is the RACH-based TA value, reported by the target cell, and included in the cell-switch command.

Clause 74. The method of any of clauses 71 to 73, wherein the method further comprises starting one or more timers that mark acquisition of either or both of the UE-based TA value or the RACH-based TA value, based on the configuration, and wherein the TA value is selected based on the one or more timers.

Clause 75. The method of any of clauses 71 to 74, wherein the UE-based TA value and the RACH-based TA value are acquired on one or more beams of the target cell, and wherein the TA value is selected based on the one or more beams.

Clause 76. The method of clause 75, wherein the TA value selected is the UE-based TA value when the UE-based TA value and the RACH-based TA value are acquired on a common beam of the target cell, and the RACH-based TA value when the UE-based TA value and the RACH-based TA value are acquired on different beams of the target cell.

Clause 77. The method of clause 75 or clause 76, wherein one or more uplink grants are provided the user equipment to access the target cell, and the TA value is selected based on the one or more uplink grants, and the one or more beams on which the UE-based TA value and the RACH-based TA value are acquired.

Clause 78. The method of clause 77, wherein the UE-based TA value and the RACH-based TA value are acquired on different beams of the target cell, and the method further comprises: receiving from the user equipment an indication of a beam of the one or more beams on which the UE-based TA value is acquired; and requesting that the target cell provide an uplink grant associated with the beam.

Clause 79. A computer-readable storage medium that is non-transitory and has computer-readable program code stored therein that, in response to execution by at least one processing circuitry, causes an apparatus to at least: receive a configuration of selection criteria for a timing advance (TA) of a target cell, acquired by respective acquisition schemes including a user equipment (UE)-based acquisition scheme and a random access channel (RACH)-based acquisition scheme; transmit a TA-acquisition command to a user equipment to trigger the user equipment to transmit a random access preamble to the target cell that is configured to acquire a RACH-based TA value according to the RACH-based acquisition scheme, the user equipment configured to acquire a UE-based TA value according to the UE-based acquisition scheme; determine cell-selection information based on the configuration; and transmit a cell-switch command to the user equipment to trigger a cell switch to the target cell, after the UE-based TA value and the RACH-based TA value are acquired, the cell-switch command including the cell-selection information, the user equipment configured to access the target cell using a TA value selected from the UE-based TA value and the RACH-based TA value, based on the configuration and the cell-selection information.

Clause 80. The computer-readable storage medium of clause 79, wherein the cell-selection information includes the RACH-based TA value, reported by the target cell, and included in the cell-switch command to the user equipment that is configured to select the TA value from the UE-based TA value and the RACH-based TA value.

Clause 81. The computer-readable storage medium of clause 79 or clause 80, wherein the computer-readable storage medium has further computer-readable program code stored therein that, in response to execution by the at least one processing circuitry, causes the apparatus to further at least: receive the UE-based TA value from the user equipment; receive the RACH-based TA value from the target cell; and select the TA value from the UE-based TA value and the RACH-based TA value, based on the configuration, and wherein the cell-selection information in the cell-switch command indicates the TA value as selected.

Clause 82. The computer-readable storage medium of clause 81, wherein the apparatus caused to select the TA value includes the apparatus caused to select a more-recently acquired one of the UE-based TA value or the RACH-based TA value.

Clause 83. The computer-readable storage medium of clause 81 or clause 82, wherein the TA value is the RACH-based TA value, reported by the target cell, and included in the cell-switch command.

Clause 84. The computer-readable storage medium of any of clauses 81 to 83, wherein the computer-readable storage medium has further computer-readable program code stored therein that, in response to execution by the at least one processing circuitry, causes the apparatus to further start one or more timers that mark acquisition of either or both of the UE-based TA value or the RACH-based TA value, based on the configuration, and wherein the TA value is selected based on the one or more timers.

Clause 85. The computer-readable storage medium of any of clauses 81 to 84, wherein the UE-based TA value and the RACH-based TA value are acquired on one or more beams of the target cell, and wherein the TA value is selected based on the one or more beams.

Clause 86. The computer-readable storage medium of clause 85, wherein the TA value selected is the UE-based TA value when the UE-based TA value and the RACH-based TA value are acquired on a common beam of the target cell, and the RACH-based TA value when the UE-based TA value and the RACH-based TA value are acquired on different beams of the target cell.

Clause 87. The computer-readable storage medium of clause 85 or clause 86, wherein one or more uplink grants are provided the user equipment to access the target cell, and the TA value is selected based on the one or more uplink grants, and the one or more beams on which the UE-based TA value and the RACH-based TA value are acquired.

Clause 88. The computer-readable storage medium of clause 87, wherein the UE-based TA value and the RACH-based TA value are acquired on different beams of the target cell, and the computer-readable storage medium has further computer-readable program code stored therein that, in response to execution by the at least one processing circuitry, causes the apparatus to further: receive from the user equipment an indication of a beam of the one or more beams on which the UE-based TA value is acquired; and request that the target cell provide an uplink grant associated with the beam.

Clause 89. An apparatus comprising means for performing the method of any of clauses 69 to 78.

Clause 90. A computer-readable medium comprising computer-readable program code that, in response to execution by at least one processing circuitry, causes an apparatus to perform the method of any of clauses 69 to 78.

Clause 91. A computer-readable storage medium comprising computer-readable program code that, in response to execution by at least one processing circuitry, causes an apparatus to perform the method of any of clauses 69 to 78.

Clause 92. A computer program comprising computer-readable program code that, in response to execution by at least one processing circuitry, causes an apparatus to perform the method of any of clauses 69 to 78.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising:
at least one memory configured to store computer-readable program code; and
at least one processing circuitry configured to access the at least one memory, and execute the computer-readable program code to cause the apparatus to at least:
receive a configuration of selection criteria for a timing advance (TA) of a target cell, acquired by respective acquisition schemes including a user equipment (UE)-based acquisition scheme and a random access channel (RACH)-based acquisition scheme;
acquire a UE-based TA value according to the UE-based acquisition scheme;
transmit a random access preamble to the target cell that is configured to acquire a RACH-based TA value according to the RACH-based acquisition scheme;
receive a cell-switch command from a serving cell to trigger a cell switch to the target cell, after the UE-based TA value and the RACH-based TA value are acquired; and
access the target cell using a TA value selected from the UE-based TA value and the RACH-based TA value, based on the configuration.

2. The apparatus of claim 1, wherein the cell-switch command includes the RACH-based TA value, reported to the serving cell by the target cell, and
wherein the at least one processing circuitry is configured to execute the computer-readable program code to cause the apparatus to further select the TA value from the UE-based TA value and the RACH-based TA value, based on the configuration.

3. The apparatus of claim 2, wherein the apparatus caused to select the TA value includes the apparatus caused to select a more-recently acquired one of the UE-based TA value or the RACH-based TA value.

4. The apparatus of claim 2, wherein the apparatus caused to select the TA value includes the apparatus caused to:
apply one of the UE-based TA value or the RACH-based TA value for a uplink transmission towards the target cell; and based on a failure of the uplink transmission, apply another of the UE-based TA value or the RACH-based TA value for a retransmission or reattempt of the transmission.

5. The apparatus of claim 2, wherein the at least one processing circuitry is configured to execute the computer-readable program code to cause the apparatus to further start one or more timers that mark acquisition of either or both of the UE-based TA value or the RACH-based TA value, based on the configuration, and
wherein the TA value is selected based on the one or more timers.

6. The apparatus of claim 2, wherein the UE-based TA value and the RACH-based TA value are acquired on one or more beams of the target cell, and
wherein the TA value is selected based on the one or more beams.

7. The apparatus of claim 6, wherein the TA value selected is the UE-based TA value when the UE-based TA value and the RACH-based TA value are acquired on a common beam of the target cell, and the RACH-based TA value when the UE-based TA value and the RACH-based TA value are acquired on different beams of the target cell.

8. The apparatus of claim 6, wherein one or more uplink grants are provided for accessing the target cell, and the TA value is selected based on the one or more uplink grants, and the one or more beams on which the UE-based TA value and the RACH-based TA value are acquired.

9. The apparatus of claim 8, wherein the TA value is one of the UE-based TA value or the RACH-based TA value, and the target cell is accessed using the TA value and one of the one or more uplink grants associated with a beam on which the one of the UE-based TA value or the RACH-based TA value is acquired.

10. The apparatus of claim 8, wherein the UE-based TA value and the RACH-based TA value are acquired on different beams of the target cell, and the at least one processing circuitry is configured to execute the computer-readable program code to cause the apparatus to further report a beam of the one or more beams on which the UE-based TA value is acquired, the beam reported to the serving cell that is configured to provide an uplink grant associated with the beam.

11. The apparatus of claim 1, wherein the at least one processing circuitry is configured to execute the computer-readable program code to cause the apparatus to further at least:
report the UE-based TA value to the serving cell; and
receive a TA-acquisition command from the serving cell to trigger transmission of the random access preamble to the target cell, and
wherein the TA value is selected at the serving cell, and the cell-switch command indicates the TA value as selected.

12. An apparatus comprising:
at least one memory configured to store computer-readable program code; and
at least one processing circuitry configured to access the at least one memory, and execute the computer-readable program code to cause the apparatus to at least:
receive a configuration of selection criteria for a timing advance (TA) of a target cell, acquired by respective acquisition schemes including a user equipment (UE)-based acquisition scheme and a random access channel (RACH)-based acquisition scheme;
transmit a TA-acquisition command to a user equipment to trigger the user equipment to transmit a random access preamble to the target cell that is configured to acquire a RACH-based TA value according to the RACH-based acquisition scheme, the user equipment configured to acquire a UE-based TA value according to the UE-based acquisition scheme;
determine cell-selection information based on the configuration; and
transmit a cell-switch command to the user equipment to trigger a cell switch to the target cell, after the UE-based TA value and the RACH-based TA value are acquired, the cell-switch command including the cell-selection information, the user equipment configured to access the target cell using a TA value selected from the UE-based TA value and the RACH-based TA value, based on the configuration and the cell-selection information.

13. The apparatus of claim 12, wherein the cell-selection information includes the RACH-based TA value, reported by the target cell, and included in the cell-switch command to the user equipment that is configured to select the TA value from the UE-based TA value and the RACH-based TA value.

14. The apparatus of claim 12, wherein the at least one processing circuitry is configured to execute the computer-readable program code to cause the apparatus to further at least:
receive the UE-based TA value from the user equipment;
receive the RACH-based TA value from the target cell; and
select the TA value from the UE-based TA value and the RACH-based TA value, based on the configuration, and
wherein the cell-selection information in the cell-switch command indicates the TA value as selected.

15. The apparatus of claim 14, wherein the apparatus caused to select the TA value includes the apparatus caused to select a more-recently acquired one of the UE-based TA value or the RACH-based TA value.

16. The apparatus of claim 14, wherein the TA value is the RACH-based TA value, reported by the target cell, and included in the cell-switch command.

17. The apparatus of claim 14, wherein the at least one processing circuitry is configured to execute the computer-readable program code to cause the apparatus to further start one or more timers that mark acquisition of either or both of the UE-based TA value or the RACH-based TA value, based on the configuration, and
wherein the TA value is selected based on the one or more timers.

18. The apparatus of claim 14, wherein the UE-based TA value and the RACH-based TA value are acquired on one or more beams of the target cell, and
wherein the TA value is selected based on the one or more beams.

19. The apparatus of claim 18, wherein the TA value selected is the UE-based TA value when the UE-based TA value and the RACH-based TA value are acquired on a common beam of the target cell, and the RACH-based TA value when the UE-based TA value and the RACH-based TA value are acquired on different beams of the target cell.

20. The apparatus of claim 18, wherein one or more uplink grants are provided the user equipment to access the target cell, and the TA value is selected based on the one or more uplink grants, and the one or more beams on which the UE-based TA value and the RACH-based TA value are acquired.
